(19) United States
(12) Patent Application Publication
(10) Pub. No.: US 2013/0314514 A1
(43) Pub. Date: Nov. 28, 2013

(54) DISPLAY APPARATUS, 3D GLASSES, AND 3D-VIDEO VIEWING SYSTEM

(71) Applicants: Kazuhiro Mochinaga, Hyogo (JP); Taiji Sasaki, Osaka (JP); Hiroshi Yahata, Osaka (JP)

(72) Inventors: Kazuhiro Mochinaga, Hyogo (JP); Taiji Sasaki, Osaka (JP); Hiroshi Yahata, Osaka (JP)

(21) Appl. No.: 13/984,368

(22) PCT Filed: Mar. 16, 2012
(86) PCT No.: PCT/JP2012/001853

§ 371 Date: Aug. 8, 2013

(30) Foreign Application Priority Data
Mar. 18, 2011 (JP) 2011-060215

(51) Int. Cl. H04N 13/04

(52) U.S. Cl. CPC H04N 13/0429
USPC 348/54

(57) ABSTRACT

A state setting unit stores a parameter indicating the state of a display device. A packet analyzing unit refers to the parameter to receive a broadcast stream, and analyzes management packets contained in the broadcast stream. A decoding unit uses a result of the analyzing to extract packets constituting broadcast content from the broadcast stream and decode the packets into video frames. A display unit displays video images represented by the video frames. A 3D video image detecting unit uses a result of the analyzing to determine whether broadcast content to be displayed contains 3D video images or not. A transmitter unit transmits a notification signal to a pair of 3D glasses when the 3D video image detecting unit detects that the broadcast content contains 3D video images. A notifying unit operates to urge the viewer to use the pair of 3D glasses in response to the notification signal.

### TECHNICAL FIELD

The present invention relates to a technology for displaying stereoscopic video images, or equivalently three-dimensional (3D) video images.

### BACKGROUND ART

Display devices, such as television receivers and personal computers, that can display 3D video images are becoming widespread in homes recent years. Such a display device is typically used in combination with a pair of 3D glasses. Such a combination is referred to as a 3D video system in the following description. The 3D video system displays 3D video images on the following principle. First of all, a 3D video image is composed of a pair of a left-view image and a right-view image. The left-view image is a two-dimensional (2D) video image seen from the viewpoint where the left eye of a viewer locates, whereas the right-view image is a 2D video image seen from the viewpoint where the right eye of the viewer does. Due to the distance between the eyes of the viewer, the left- and right-view images show the same object appearing in slightly different forms: shapes, patterns, colors, and so on. The display device alternately displays the left- and right-view images on its screen. The viewer watches the video images through the 3D glasses. The left lens of the 3D glasses selectively transmits the left-view image, whereas the right lens does the right-view image. In one example, the display device uses lights polarized in different directions between the left- and right-view images. The 3D glasses have lenses each coated with a polarization film such that the left lens selectively transmits polarized components representing the left-view image and the right lens does ones representing the right-view image. In another example, the display device notifies the 3D glasses of when it switches from the left-view image to the right-view one, or vice versa. The 3D glasses have lenses each composed of a liquid crystal panel; the left lens selectively transmits light while the display device displays the left-view image, and the right lens does while the display device displays the right-view image. In this way, the viewer perceives the left-view image only with the left eye, and the right-view image only with the right eye. In this case, the viewer falsely recognizes the differences in form of the object between the left- and right-view images as binocular parallax, and thus perceives the stereoscopic illusion of the object.

With the widespread use of the 3D video systems in homes, it is expected for television broadcasts to include more and more broadcast contents containing 3D video images. On the other hand, any viewer needs to use the 3D glasses to view 3D video images with the 3D video system, as described above. Accordingly, increase in number of the broadcast contents containing 3D video images requires the viewer to put the 3D glasses on and off more and more frequently while he or she watches television broadcasts. A conventional 3D video system has the viewer bear the burden of determining whether broadcast content to be watched contains 3D video images or not, and thus determining whether to use the 3D glasses or not. As a result, the viewer may fail to realize that the 3D glasses are required to watch video images displayed on the display device, until seeing double thereon.

As a technology to prevent a viewer from unintentionally watching 3D video images with the unaided eye, one disclosed in Patent Literature 1 is known, for example. The technology enables a pair of 3D glasses to use a built-in sensor to detect that a viewer wears the 3D glasses, and then issue a notification to a display device. In response to the notification, the display device switches video images displayed on its screen from 2D ones to 3D ones. In this way, the display device does not display 3D video images unless the viewer wears the 3D glasses. This prevents the viewer from watching 3D video images with the unaided eye.

### [Citation List]

### [Patent Literature]

### [Patent Literature 1]

Japanese Patent Application Publication No. 2010-154533

### SUMMARY OF INVENTION

### [Technical Problem]

The conventional 3D video system may allow 3D video images to suddenly appear on a screen upon power-on of a display device and upon the start of displaying broadcast content preselected to be watched. The 3D video system therefore involves the risk that a viewer cannot wear 3D glasses in time. To enable the viewer to avoid the risk needs, prior to the power-on and the start of displaying the broadcast content preselected, to inform the viewer of presence of 3D video images in the broadcast content to be watched, and thus urge him or her to use 3D glasses. The technology taught in Patent Literature 1 prevents the display device from displaying 3D video images unless the viewer wears the 3D glasses. Therefore, the technology needs some ingenuity to make the viewer aware of the use of the 3D glasses allowing him or her to watch the 3D video images.

When a notification to urge a viewer to use 3D glasses is expressed by an on-screen display of a display device, the viewer may fail to find any pair of 3D glasses immediately. In view of this, it is desirable that the notification is expressed by an operation of 3D glasses rather than the on-screen display of the display device. The operation of the 3D glasses enables the viewer to become aware of the notification, and at the same time, find where the 3D glasses locate.

An object of the present invention is to provide a 3D video system that enables a pair of 3D glasses to operate to urge a viewer to use the 3D glasses before a display device displays 3D video images contained in broadcast content.

### [Solution to Problem]

A 3D video system according to the present invention is to be used by a viewer to watch video images of broadcast content; the system includes a display device and a pair of 3D glasses. The display device receives a broadcast stream representing the broadcast content to display 2D or 3D video images of the broadcast content. The pair of 3D glasses is to be used by the viewer to watch 3D video images.

The display device includes a state setting unit, a packet analyzing unit, a decoding unit, a display unit, a 3D video image detecting unit, and a transmitter unit.

The state setting unit stores a parameter therein; the parameter indicates a state of the display device. The packet analyzing unit refers to the parameter stored in the state setting unit to receive the broadcast stream, and analyzes management packets contained in the broadcast stream. The decoding unit uses a result of analyzing by the packet analyzing unit to extract packets that constitute the broadcast content from the broadcast stream and decode the packets into a series of video frames. The display unit displays 2D or 3D video images represented by the series of video frames. The 3D video image detecting unit uses a result of analyzing by the packet analyzing unit to determine whether broadcast content to be displayed contains 3D video images or not. The transmitter unit transmits a notification signal to the pair of 3D glasses when the 3D video image detecting unit detects that the broadcast content to be displayed contains 3D video images.

The pair of 3D glasses includes a left lens, a right lens, a receiver unit, and a notifying unit. The left lens selectively transmits left-view images displayed on the display device. The right lens selectively transmits right-view images displayed on the display device. The receiver unit receives the notification signal from the display device. The notifying unit operates to urge the viewer to use the pair of 3D glasses in response to the notification signal.

### [Advantageous Effects of Invention]

The 3D video system according to the present invention allows the display device to refer to the parameter indicating the state of the display device. This enables the display device to identify broadcast content to be displayed from among broadcast contents represented by the broadcast stream. The display device further analyzes the management packets contained in the broadcast stream, and uses a result of the analyzing to determine whether the broadcast content to be displayed contains 3D video images or not. The display device thus enables the determining to precede the displaying of the 3D video images. When the broadcast content to be displayed contains 3D video images, the display device transmits the notification signal to the pair of 3D glasses, and in response to the notification signal, the pair of 3D glasses operates to urge the viewer to use the 3D glasses. As described above, the 3D video system according to the present invention enables the pair of 3D glasses to operate to urge the viewer to use the 3D glasses before the display device displays 3D video images contained in broadcast content.

### BRIEF DESCRIPTION OF DRAWINGS

FIG. 1 is a schematic diagram showing a 3D video system according to Embodiment 1 of the present invention.

FIG. 2 is a schematic diagram showing the principle of frame sequential 3D video display.

FIGS. 3A-3D are schematic diagrams respectively showing light emission, sound generation, vibration, and control of lenses by a notifying unit of the 3D glasses 102 shown in FIG. 1.

FIG. 4 is a schematic diagram showing the data structure of a broadcast stream.

FIG. 5 is a schematic diagram showing the data structure of a video stream.

FIGS. 6A-6D are schematic diagrams respectively showing side-by-side, top-and-bottom, line-by-line, and checkerboard formats, which are varieties used for storing a pair of video frames.

FIG. 7 is a schematic diagram showing the data structure of a PMT.

FIG. 8 is a schematic diagram showing the data structure of an EIT.

FIG. 9A is a schematic diagram showing the data structure stipulated by the ARIB standards as that of a content descriptor 832 shown in FIG. 8, and FIG. 9B is a schematic diagram showing the data structure of content genre information shown in FIG. 9A.

FIG. 10 is a block diagram showing the configuration of a display device 101 shown in FIG. 1.

FIG. 11 is a flowchart of operation of the display device 101 shown in FIG. 1 to transmit a notification signal NF when broadcast content to be displayed is one currently put on the air.

FIG. 12 is a flowchart of operation of the display device 101 shown in FIG. 1 to transmit a notification signal NF when broadcast content to be displayed is one preselected to be watched.

FIG. 13 is a block diagram showing an example of the configuration of the 3D glasses 102 shown in FIG. 1.

FIG. 14 is a block diagram showing another example of the configuration of the 3D glasses 102 shown in FIG. 1.

FIG. 15 is a block diagram showing the configuration of a pair of 3D glasses according to Embodiment 2 of the present invention.

FIG. 16 is a block diagram showing the configuration of a pair of 3D glasses according to Reference Embodiment 1.

FIG. 17 is a block diagram showing the configuration of a pair of 3D glasses according to Reference Embodiment 2.

FIG. 18 is a block diagram showing the configuration of a pair of 3D glasses according to Reference Embodiment 3.

FIG. 19 is a block diagram showing the configuration of a pair of 3D glasses according to Reference Embodiment 4.

FIG. 20 is a block diagram showing the configuration of a pair of 3D glasses according to Reference Embodiment 5.

FIG. 21 is a block diagram showing the configuration of a pair of 3D glasses and a lighting fixture both according to Reference Embodiment 6.

FIG. 22 is a block diagram showing the configuration of a pair of 3D glasses and a lighting fixture both according to Reference Embodiment 7.

### DESCRIPTION OF EMBODIMENTS

The following describes preferred embodiments of the present invention with reference to the drawings.

### Embodiment 1

[Configuration of 3D video System]

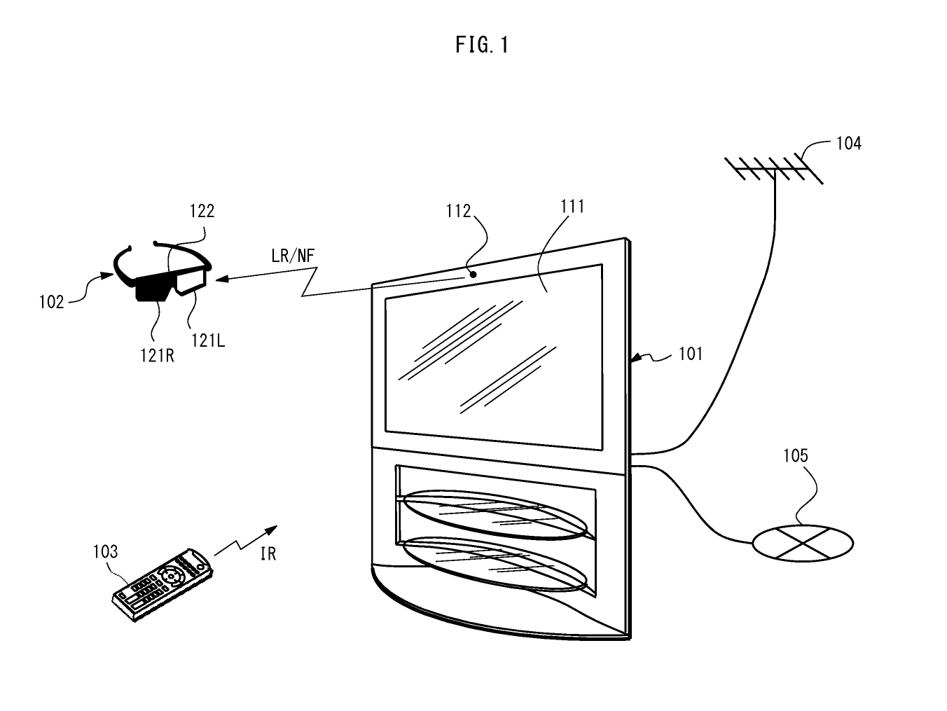

FIG. 1 is a schematic diagram showing a 3D video system according to Embodiment 1 of the present invention. The system employs a frame sequential method as a method for using parallax images to display 3D video images. Referring to FIG. 1, the system includes a display device 101, a pair of 3D glasses 102, and a remote control 103.

The display device 101 includes a display panel 111 composed of a liquid crystal display. The display device 101 receives digital broadcasting waves of terrestrial broadcasting or satellite broadcasting (BS) through an antenna 104 to convert the broadcasting waves into a broadcast stream. The display device 101 also receives a broadcast stream distributed by a cable television system or the like via a network 105, such as the Internet. The broadcast streams are digital streams representing broadcast content. The broadcast content is the entirety or a section of a broadcast program or an advertisement. The broadcast content may alternatively be video content such as a movie or a homemade video downloadable from the Internet. Each broadcast stream includes a video stream, an audio stream, and management packets. The video stream represents video images of broadcast content, whereas the audio stream does sounds thereof. The management packets contain information showing the structure of the broadcast stream, information about the broadcast content, and so on. When the broadcast content contains 3D video images, their left- and right-view images are multiplexed in a single video stream, or separately stored in different video streams. The display device 101 first separates and analyzes the management packets from the broadcast stream to determine the structure of the broadcast stream. The display device 101 next separates video and audio streams from the broadcast stream, based on the structure of the broadcast stream. The video stream is decoded into a series of video frames, whereas the audio stream is into audio data. The display device 101 causes the display panel 111 to display video images represented by the respective video frames, and a built-in speaker to reproduce sounds according to the audio data. The display device 101 also extracts the information about the broadcast content from the management packets, and then uses it to generate an electronic program guide (EPG) and cause the display panel 111 to display the EPG.

The display device 101 has two operation modes: a 2D display mode and a 3D display mode. The display device 101 in the 2D display mode causes the display panel 111 to display a series of video frames at a frame rate for 2D video images, e.g., 60 fps. When broadcast content contains 3D video images, the display panel 111 displays either left- or right-view images. The display device 101 in the 3D display mode causes the display panel 111 to display a series of video frames at a frame rate for 3D video images, e.g.,120 fps. When broadcast content contains 3D video images, the display panel 111 alternately displays left- and right-view images.

The display device 101 includes a transmitter unit 112. The transmitter unit 112 transmits a left-right signal LR or a notification signal NF to the 3D glasses 102 via infrared rays or radio waves. The left-right signal LR indicates whether images currently displayed on the display panel 111 is left- or right-view images. The display device 101 in the 2D display mode prevents the transmitter unit 112 from transmitting the left-right signal LR. The display device 101 in the 3D display mode causes the transmitter unit 112 to change the left-right signal LR at each switching of a video frame displayed on the display panel 111 from left- to right-view ones, and vice versa. The notification signal NF indicates that the display device 101 requests the 3D glasses 102 to operate to urge a viewer to use the 3D glasses 102. The display device 101 separates and analyzes management packets assigned to broadcast content to be displayed from a broadcast stream during power-off of the display panel 111 or under the condition that broadcast content to be watched is preselected. Thus, the display device 101 determines whether the broadcast content to be displayed contains 3D video images or not. Note that the “broadcast content to be displayed” means broadcast content to be distributed by a provider or broadcasting station that the display device is programmed to select at power-on of the display panel 111, or broadcast content preselected to be watched. When the broadcast content to be displayed contains 3D video images, the display device 101 causes the transmitter unit 112 to transmit the notification signal NF to the 3D glasses 102.

The 3D glasses 102 are a type of shutter ones, and include a left lens 121L, a right lens 121R, a receiver unit 122, and a notifying unit (not shown in FIG. 1.) The left lens 121L and the right lens 121R are each composed of a liquid crystal display panel. Each of the lenses 121L and 121R operates in the normally white mode; its entirety transmits light until receiving an instruction from the receiver unit 122, and then blocks light in response to the instruction. The receiver unit 122 receives the left-right signal LR from the transmitter unit 112 of the display device 101, and then sends the instructions to the lenses 121L and 121R in response to the changes of the left-right signal LR. The receiver unit 122 also sends an instruction to the notifying unit when receiving the notification signal NF from the transmitter unit 112 of the display device 101. The notifying unit operates to urge a viewer to use the 3D glasses 102 in response to the instruction from the receiver unit 122. Details of the operating will be described below.

The remote control 103 includes an operation unit and a transmitter unit. The operation unit includes a plurality of buttons. Each button is assigned to a function of the display device 101, such as power-on and off, channel selection, and volume control. The operation unit detects a button pushed by a user, and then transmits identification information of the button to the transmitter unit. The transmitter unit converts the identification information into an infrared or radio signal IR to transmit it to the display device 101. On the other hand, the display device 101 receives the signal IR, and then specifies the button from the signal IR to execute the function assigned to the button.

### [Principle of Frame Sequential 3D Video Display]

Until receiving the left-right signal LR, the receiver unit 122 does not send any instruction to either of the lenses 121L and 121R, and thus, both the lenses 121L and 121R transmit light. Since the display device 101 in the 2D display mode does not transmit the left-right signal LR, 2D video images displayed on the display device 101 are seen by both the eyes of a viewer even if he or she wears the 3D glasses 102. When the left-right signal LR indicates display of left-view images, the receiver unit 122 sends an instruction to the right lens 121R. In response, the left lens 121L transmits light, and the right lens 121R blocks light. Conversely, when the left-right signal LR indicates displaying right-view images, the receiver unit 122 sends an instruction to the left lens 121L. In response, the left lens 121L blocks light, and the right lens 121R transmits light. The display device 101 in the 3D display mode changes the left-right signal LR synchronously with the switching of frames. Therefore, the left lens 121L and the right lens 121R alternately transmit light synchronously with the changes of the left-right signal LR. Consequently, left-view images are seen only by the left eye of a viewer who watches the display panel 111 through the 3D glasses 102, and right-view images are only by the right eye.

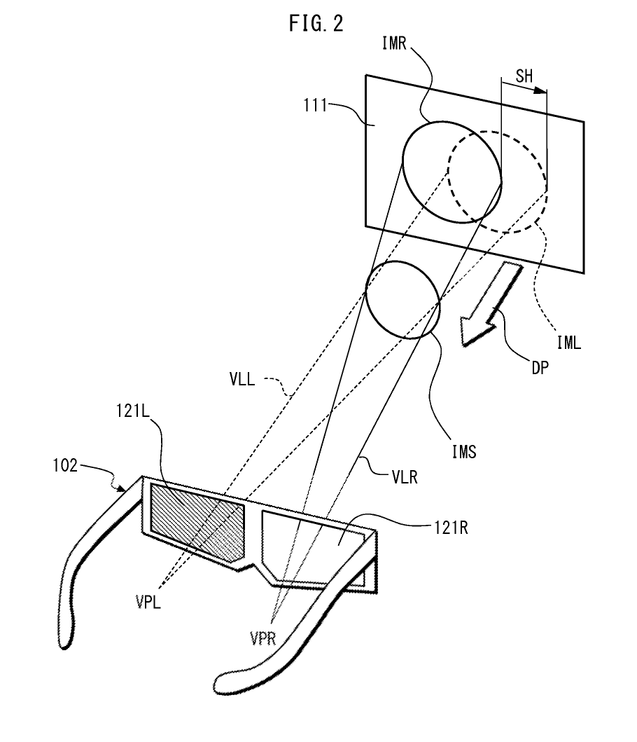

FIG. 2 is a schematic diagram showing the principle of frame sequential 3D video display. As indicated by the solid lines in FIG. 2, the left lens 121L blocks light and the right lens 121R transmits light when a right-view image IMR is displayed on the display panel 111 of the display device 101. Therefore, the right-view image IMR only reaches the viewpoint VPR where a viewer's right eye locates. Conversely, as indicated by the broken lines in FIG. 2, the left lens 121L transmits light and the right lens 121R blocks light when a left-view image IML is displayed on the display panel 111. Therefore, the left-view image IML only reaches the viewpoint VPL where the viewer's left eye locates. Note that the right-view image IMR and the left-view image IML locate on the display panel 111 at positions horizontally different by a shift amount SH. Therefore, a line of sight VLR connecting the right-eye's viewpoint VPR to the right-view image IMR intersects another line of sight VLL connecting the left-eye's viewpoint VPL to the left-view image IML at a point separate from the display panel 111 in its front-back direction. In the example shown in FIG. 2, the point of intersection is closer to the viewer than the display panel 111; the point locates at the distance indicated by an arrow DP from the panel. A sufficiently high frame rate causes the left-view image IML to be perceived by the left eye while an afterimage of the right-view image IMR continues to appear on the right eye. At that time, the viewer falsely perceives the horizontal shift SH between the right-view image IMR and the left-view image IML as binocular parallax of a single 3D object. As a result, the viewer sees a single stereoscopic image IMS as if it floats at the intersection between the right-eye's line of sight VLR and the left-eye's line of sight VLL, and then stays at a depth DP different from that of the display panel 111.

[Operating of Notifying Unit of 3D Glasses]The operating of the notifying unit in response to the instruction from the receiver unit 122 aims at urging a viewer who has not yet worn the 3D glasses 102 to wear them. Therefore, it is desirable that the operating serves to signal the location of the 3D glasses 102 to the viewer.

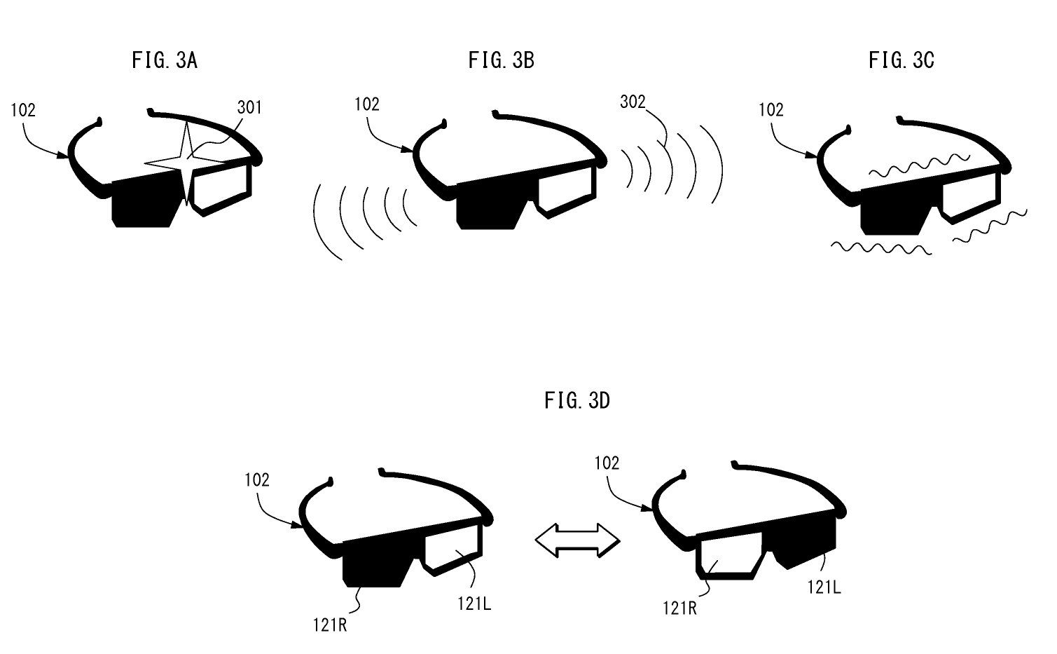

FIG. 3A is a schematic diagram showing light emission by the notifying unit. The notifying unit includes a light emission unit such as en LED. The light emission unit is mounted between the lenses 121L and 121R, and emits visible light 301 as shown in FIG. 3A. The light 301 keeps its brightness at a constant level, blinks periodically, or changes its brightness or color according to a specific pattern. Alternatively, a plurality of light emission units may be mounted on the frame of the 3D glasses 102 to shine the entirety of the frame. The notifying unit causes the light emission unit to emit the light 301 in response to the instruction from the receiver unit 122; this serves as the operating to urge the viewer to use the 3D glasses 102. By seeing the light 301, the viewer becomes aware of the location of the 3D glasses 102 and the need to use them.

FIG. 3B is a schematic diagram showing sound generation by the notifying unit. The notifying unit includes a sound generating unit such as a small speaker.

The sound generating unit is mounted on the frame of the 3D glasses 102, and emits an audible sound 302 as shown in FIG. 3B. The sound 302 is a monotonous sound such as a beep, a passage of music, a rhythmical sound, or a voice of a human or animal. The notifying unit causes the sound generating unit to emit the sound 302 in response to the instruction from the receiver unit 122; this serves as the operating to urge the viewer to use the 3D glasses. By hearing the sound 302, the viewer becomes aware of the location of the 3D glasses 102 and the need to use them.

FIG. 3C is a schematic diagram showing vibration by the notifying unit. The notifying unit includes a vibrator unit with a vibratile member built in. The vibrator unit is mounted on the frame of the 3D glasses 102 to vibrate its entirety as shown in FIG. 3C. The vibration is strong enough to be felt by a person who puts the 3D glasses 102 in his or her pocket or the like, or holds them with his or her hand. The notifying unit causes the vibrator unit to vibrate the vibratile member in response to the instruction from the receiver unit 122; this serves as the operating to urge the viewer to use the 3D glasses 102. By feeling the vibration, the viewer becomes aware of the location of the 3D glasses 102 and the need to use them.

FIG. 3D is a schematic diagram showing control of the lenses by the notifying unit. Instead of the receiver unit 122, the notifying unit transmits an instruction to the lenses 121L and 121R to cause them to block light. In particular, the notifying unit causes the lenses 121L and 121R alternately to block light in response to the instruction from the receiver unit 122; this serves as the operating to urge the viewer to use the 3D glasses 121. Indeed, the respective lenses 121L and 121R flicker due to their transmitted lights. By seeing the flickering lenses, the viewer becomes aware of the location of the 3D glasses 102 and the need to use them.

The notifying unit operates as shown in FIGS. 3A-3D when the receiver unit 122 receives the notification signal NF. The notification signal NF is transmitted from the display device 101 to the 3D glasses 102 when broadcast content to be displayed contains 3D video image. Accordingly, the above-described operating by the notifying unit indicates that the broadcast content to be displayed contains 3D video images. The broadcast content to be displayed is one that a viewer intends to have the display device 101 display. Therefore, the viewer, if putting on the 3D glasses 102 in response to the above-described operating by the notifying unit, successfully starts using them before 3D video images contained in the broadcast content to be displayed appear on the display device 101. As a result, it is possible to have the viewer avoid watching the 3D video images with the unaided eye.

### [Data Structure of Broadcast Stream]

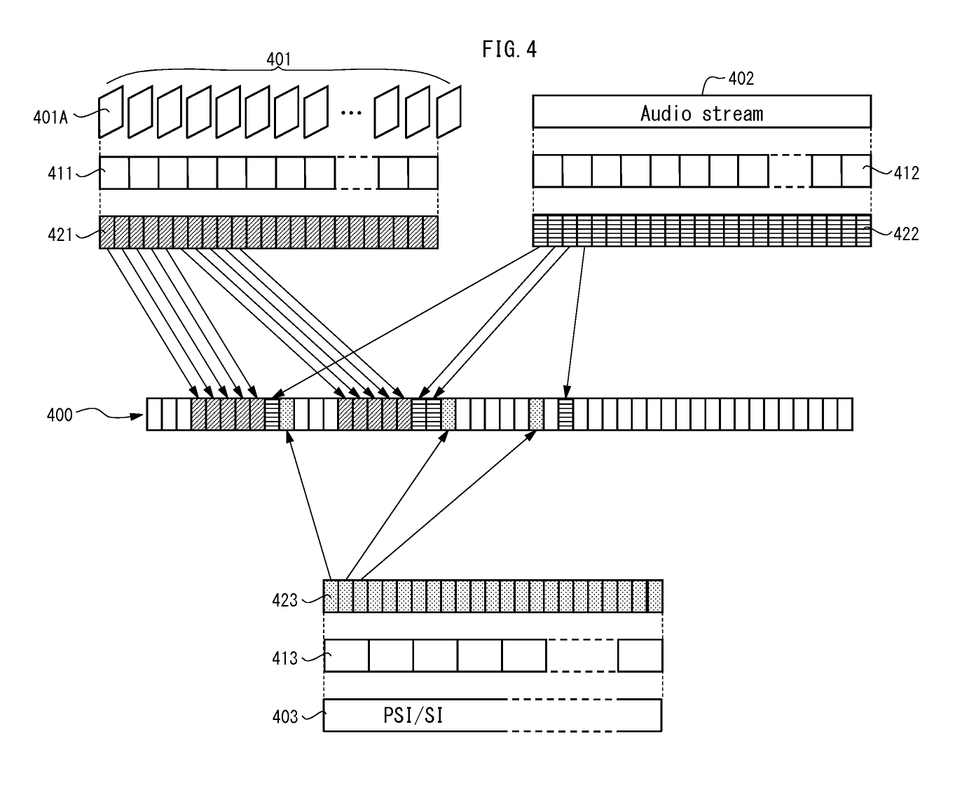

FIG. 4 is a schematic diagram showing the data structure of a broadcast stream. The broadcast stream 400 is a digital stream represented in the MPEG-2 transport stream (TS) format, which consists of various types of TS packets 421, 422, and 423. The TS packets 421-423 are each 188 bytes long. Different types of the TS packets 421-423 contain fragments divided from different types of elementary streams 401 and 402 and management packets 403. The term “elementary stream” is a generic name for digital streams representing video images, sounds, and subtitles of broadcast content. Types of elementary streams include a video stream 401 and an audio stream 402. In addition, a subtitle stream may be included. The management packets 403 are roughly classified into program specific information (PSI) ones and service information (SI) ones. PSI contains information representing the structure of a broadcast stream, and more specifically information representing a list of elementary streams constituting the broadcast stream. SI, which is an extension of PSI, contains information about the provider, broadcasting station, and broadcast content of the broadcast stream. The elementary streams 401 and 402 and the management packets 403 are assigned packet identifiers (PIDs) different by types. A PID is contained in the header of each TS packet, and the PID is assigned to the elementary stream or management packet whose fragment is contained in the payload of the TS packet. Therefore, the PID in the header of a TS packet identifies the type of the TS packet.

The elementary streams 401 and 402 and the management packets 403 are multiplexed into the broadcast stream 400 as follows. First, video frames 401A constituting the video stream 401 are each encoded into one picture, and then stored into one packetized elementary stream (PES) packet 411. The header of each PES packet 411 contains a presentation time stamp (PTS) and decoding time stamp (DTS) of the picture contained in the PES packet. The PTS of the picture indicates the time at which a video frame decoded from the picture is to be displayed on a screen. The DTS of the picture indicates the time at which the picture is to be decoded. Subsequently, each PES packet 411 is usually divided into a plurality of fragments, and then each fragment is stored into one TS packet 421. Similarly, the audio stream 402 and the management packets 403 are first converted into series of PES packets 412 and 413, and then into series of TS packets 422 and 423, respectively. Finally, the TS packets 421-423 obtained from the elementary streams 401 and 402 and the management packets 403 are time-division multiplexed into the single digital stream 400.

### [Data Structure of Video Stream]

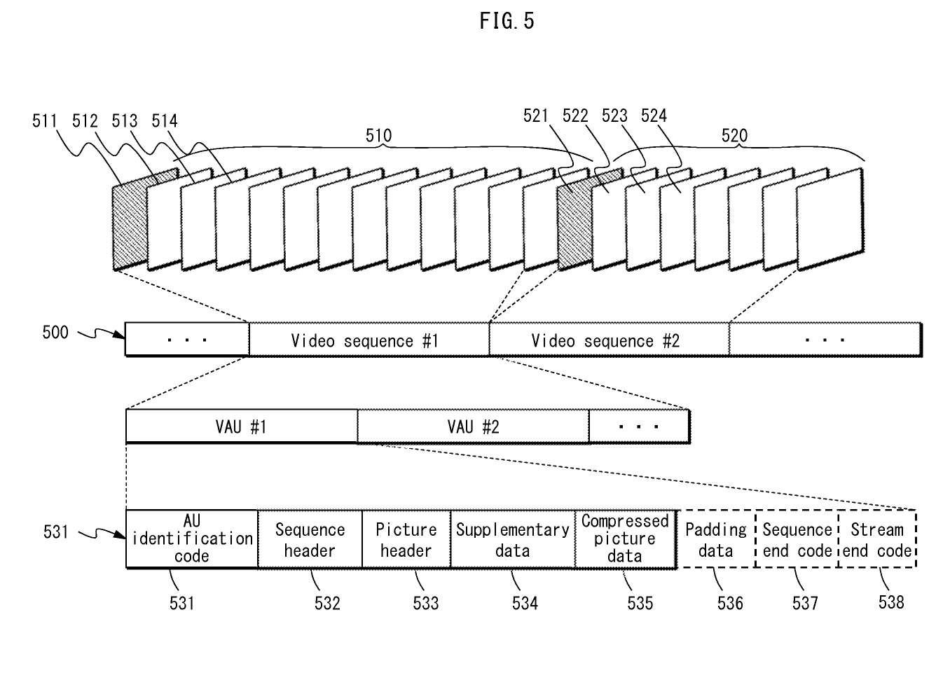

FIG. 5 is a schematic diagram showing the data structure of a video stream. A video frame is a two-dimensionally array of pixel data. A set of pixel data is a combination of a chromaticity coordinate value and an a value (opacity). The chromaticity coordinate value is expressed as an RGB or YCrCb value. The video frames are encoded into pictures 511, 512, 513, 514, 521, 522, 523, and 524 by a video compression coding method, examples of which include MPEG-2, MPEG-4 AVC, and SMPTE VC-1. The pictures 511-514 and 521-524 are generally divided into a plurality of Groups of Pictures (GOPs) 510 and 520. A GOP is a series of pictures composed of successive pictures that starts with an I (Intra) picture at the top of the sequence. An “I picture” refers to a picture compressed by intra-picture coding. A GOP generally includes P (predictive) pictures and B (bidirectionally predictive) pictures in addition to an I picture. A “P picture” refers to a picture compressed by inter-picture predictive coding with one reference picture, which is either an I picture or another P picture that has an earlier presentation time. A “B picture” refers to a picture compressed by inter-picture predictive coding with two reference pictures, which are either I pictures or P pictures that have an earlier or later presentation time. To decode a video frame from a B picture, a reference picture needs to be decoded first. In general, a B picture and its reference pictures therefore have DTSs in a different order than that of PTSs. In each GOP, pictures are arranged in the order of the DTSs.

Referring to FIG. 5, the video stream 500 is generally composed of a plurality of video sequences #1, #2 . . . A “video sequence” refers to a combination of pictures 511, 512, 513, 514, . . . that constitute a single GOP 510 and additional information, such as a header, attached to the individual pictures. The combination of this additional information and a picture is referred to as a Video Access Unit (VAU). Consequently, one video sequence is composed of as many VAUs #1, #2 . . . as the pictures contained in one GOP.

FIG. 5 further shows the structure of a VAU #1 530 located at the top of each video sequence included in the video stream 500. The VAU #1 530 includes an Access Unit (AU) identification code 531, a sequence header 532, a picture header 533, supplementary data 534, and compressed picture data 535. The second and subsequent VAU #2, ... each have the same structure as VAU #1 530 except for lack of the sequence header 532. The AU identification code 531 is a predetermined code indicating the top of the VAU #1 530. The sequence header 532 is also called a GOP header and includes an identification number for the video sequence #1 that includes the VAU #1 530. The sequence header 532 also includes information common throughout the whole GOP 510. The common information indicates, for example, resolution, frame rate, aspect ratio, and bit rate. The common information also includes video display information. The video display information includes cropping area information and scaling information. The cropping area information defines an area in one video frame and the area is to be actually displayed on the screen. The scaling information indicates the aspect ratio with which the area defined by the cropping area information is displayed on the screen. The picture header 533 indicates a unique identification number, identification number of the video sequence #1, and information necessary for decoding the picture, such as the type of codec. The supplementary data 534 includes additional information regarding matters other than the decoding of the picture, for example closed caption text information, information on the GOP structure, and time code information. The compressed picture data 535 contains the picture. The VAU #1 530 may additionally include any or all of padding data 536, a sequence end code 537, and a stream end code 538 as necessary. The padding data 536 is dummy data. By adjusting the size of padding data according to that of the compressed picture data 535, the bit rate of VAU #1 530 is maintained at a predetermined value. The sequence end code 537 indicates that the VAU #1 530 is located at the end of the video sequence #1. The stream end code 538 indicates the end of the video stream 500.

The specific details of each component in a VAU differ according to the encoding method of the video stream 500. Suppose, for example, that the codec is MPEG-4 AVC. Then, the components in the VAU shown in FIG. 5 are composed of a single Network Abstraction Layer (NAL) unit. Specifically, the AU identification code 531, the sequence header 532, the picture header 533, the supplementary data 534, the compressed picture data 535, the padding data 536, the sequence end code 537, and the stream end code 538 respectively correspond to an Access Unit (AU) delimiter, a Sequence Parameter Set (SPS), a Picture Parameter Set (PPS), a Supplemental Enhancement Information (SEI), a view component, filler data, an end of sequence, and an end of stream.

### <3D Video Stream>

When broadcast content contains 3D video images, pairs of left- and right-view frames constituting the 3D video images are transmitted by either a frame or service compatible method. In the frame compatible method, a pair of video frames is compressed to the amount of data comparable to one video frame and then transmitted. In the service compatible method, a pair of video frames is left uncompressed to be treated as one video frame and then transmitted using twice the bandwidth.

In the frame compatible method, first, left- and right-view frames are compressed one by one, and then stored into a data area for storing one video frame.

Next, each video frame is coded into one picture. The storage formats of compressed video frame pairs include side-by-side, top-and-bottom, line-by-line, and checkerboard ones.

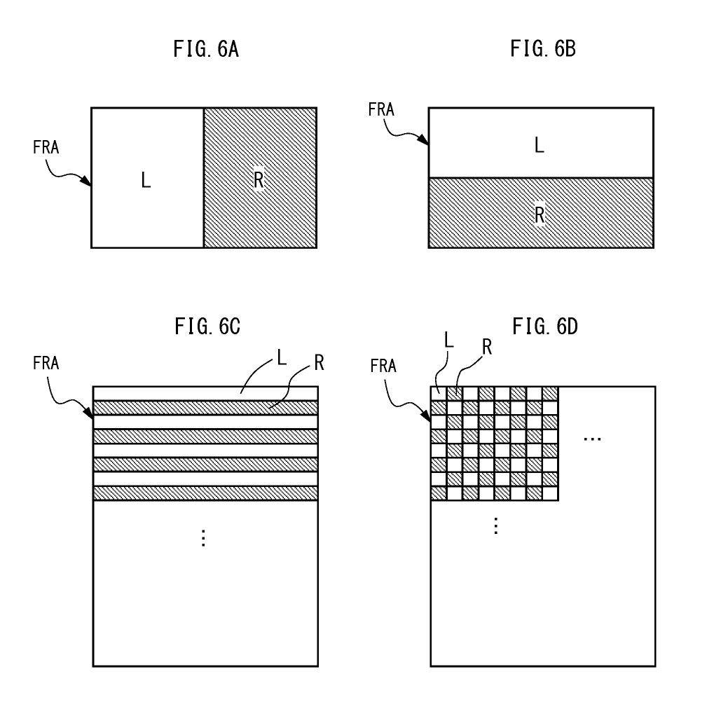

FIG. 6A is a schematic diagram showing a side-by-side format. Referring to FIG. 6A, the left-half of a data area FRA for one video frame stores a left-view frame L having been compressed to ½ in the horizontal direction, whereas the right half stores a right-view frame R having been compressed to ½ in the horizontal direction.

FIG. 6B is a schematic diagram showing a top-and-bottom format. Referring to FIG. 6B, the top-half of the data area FRA for one video frame stores a left-view frame L having been compressed to ½ in the vertical direction, whereas the bottom-half stores a right-view frame R having been compressed to ½ in the vertical direction.

FIG. 6C is a schematic diagram showing a line-by-line format. Referring to FIG. 6C, first, the left-view frame L and the right-view frame R are both compressed to ½ in the vertical direction. Next, the odd-numbered lines of the data area FRA for one video frame store the left-view frame L line by line, whereas the even-numbered lines store the right-view frame R line by line.

FIG. 6D is a schematic diagram showing a checkerboard format. Referring to FIG. 6D, first, the left-view frame L and the right-view frame R are both compressed to ½ either in the horizontal or vertical direction. Next, each of the video frames L and R is divided into rectangle fragments and the fragments are alternately arranged in the data area FRA for one video frame to define a checkered pattern.

On the other hand, the service compatible method includes a frame packing format. According to the frame packing format, first, one of the left- and right-view frames is compressed into a picture by using the temporal redundancy. Next, the other of the left- and right-view frames is compressed into a picture by using the redundancy between the left- and right-view frames in addition to the temporal redundancy. That is, one of the left- and right-view frames is compressed with reference to the other. One of such video compression encoding methods known in the art is the revised standards for MPEG-4 AVC/H.264, called Multiview Video Coding (MVC). The MVC inter-view prediction exploits similarity between video images from differing perspectives, in addition to temporal similarity in video images. This type of predictive coding has a higher video compression ratio than predictive coding that individually compresses data of video images seen from each perspective. A pair of left- and right-view pictures is stored into a data area for one video frame which has been expanded by two times either horizontally or vertically before being transmitted.

Information indicating whether the frame or service compatible method is used to store a 3D video stream in the broadcast stream is included in the management packets. When the broadcast stream contains a 3D video stream in the frame compatible method, the management packets additionally include 3D video format information indicating the storage format of the left- and right-view frames employed in the video stream. The 3D video format information may also be stored in each VAU of the 3D video stream or in the supplementary data 534 contained in the top VAU (see FIG. 5) in each video sequence.

### [Data Structure of Audio Stream]

Audio streams are roughly classified into a primary audio stream and a secondary audio stream. The primary audio stream represents the primary audio of broadcast content. The secondary audio stream represents secondary audio to be mixed with the primary audio, such as sound effects accompanying operation of an interactive screen. A different audio stream is provided for a different language of audio. Therefore, one broadcast stream typically includes a plurality of audio streams multiplexed therein. Each audio stream is encoded by a method such as AC-3, Dolby Digital™ Plus, Meridian Lossless Packing (MLP™), Digital Theater System (DTS™), DTS-HD, or linear Pulse Code Modulation (PCM).

### [Data Structure of Management Packet]

Among management packets, PSI ones are stipulated by European digital broadcasting standards. Types of PSI include a program association table (PAT), program map table (PMT), and program clock reference (PCR). The PAT shows the PID of the PMT included in a broadcast stream. The PAT itself is assigned a PID of 0. The PMT packet is suitable to be termed a content management packet, and contains information for managing elementary streams constituting a broadcast stream. More specifically, the PMT includes the PID and attribute information of each elementary stream. The PMT also includes various descriptors about the broadcast stream. The PCR indicates the time at which the display device 101 should separate the PCR from the broadcast stream. The time is used by a decoder in the display device 101 as a reference for PTSs and DTSs.

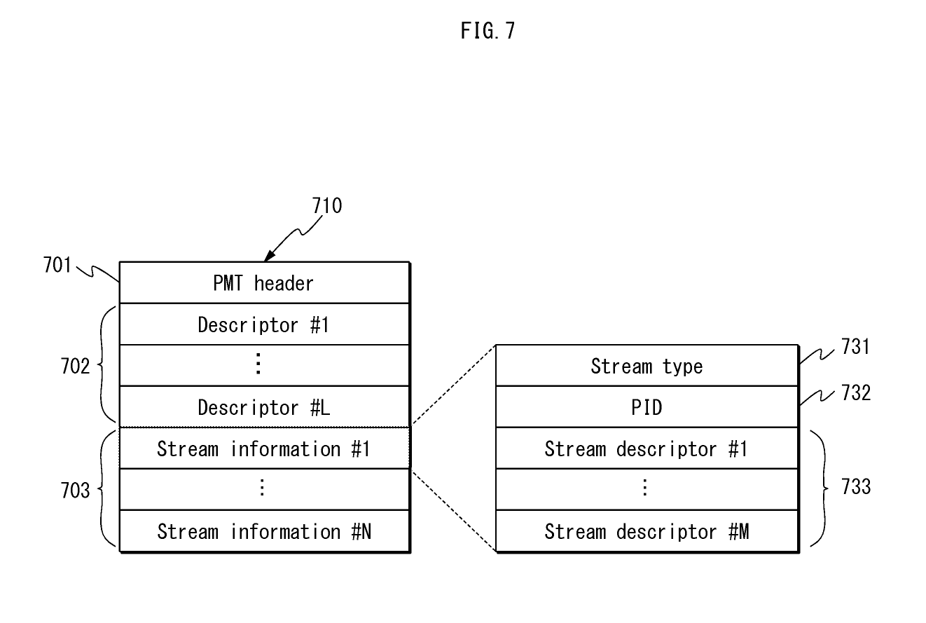

FIG. 7 is a schematic diagram showing the data structure of a PMT 710. The PMT 710 includes a PMT header 701, descriptors 702, and stream information 703. The PMT header 701 indicates the length, etc., of data stored in the PMT 710. The descriptors 702 each indicate information about the entirety of broadcast content assigned to the PMT 710. For example, one of the descriptors 702 includes copy control information showing whether copy of the broadcast content is enabled or disabled. In particular, when the broadcast stream contains a 3D video stream, one of the descriptors 702 includes information indicating whether a frame or service compatible method is used. That descriptor 702 additionally includes 3D video format information when the frame compatible method is used, and information indicating whether a frame packing format is used or not when the service compatible method is used. The stream information 703 relates to each elementary stream included in broadcast content assigned to the PMT 710. Different pieces of the stream information 703 are assigned to different elementary streams. The stream information 703 of each elementary stream includes a stream type 731, a PID 732, and stream descriptors 733. The stream type 731 includes the identification information, etc., of a codec that was used to compress the elementary stream. The PID 732 shows the PID of the elementary stream. The stream descriptors 733 include attribute information of the elementary stream, such as its frame rate and aspect ratio.

Among the management packets, SI ones are stipulated differently by digital broadcasting standards. For example, the standards developed by the Digital Video Broadcasting project (DVB) and the standards, ARIB STD-B10, developed by the Association of Radio Industries and Businesses (ARIB) individually define as SI a service description table (SDT) and an event information table (EIT). Those tables are used for generating EPG. The SDT is a table showing correspondence between providers and broadcasting stations of broadcast streams and their own identifiers (service IDs). In particular, the SDT includes the names of the providers and broadcasting stations. The PID of the SDT is fixed at 0x0011. The EIT packet is suitable to be termed a broadcast guidance information packet, and contains information for identifying broadcast content. The EIT is roughly classified into the following two types: 1. a first type containing information about currently on-air broadcast contents and their subsequent ones; and 2. a second type indicating a distribution schedule of broadcast contents. In general, the first and second types of EIT locate in a digital terrestrial television broadcasting wave at intervals of a few seconds and hours, respectively. The PID of the EIT is fixed at 0x0012.

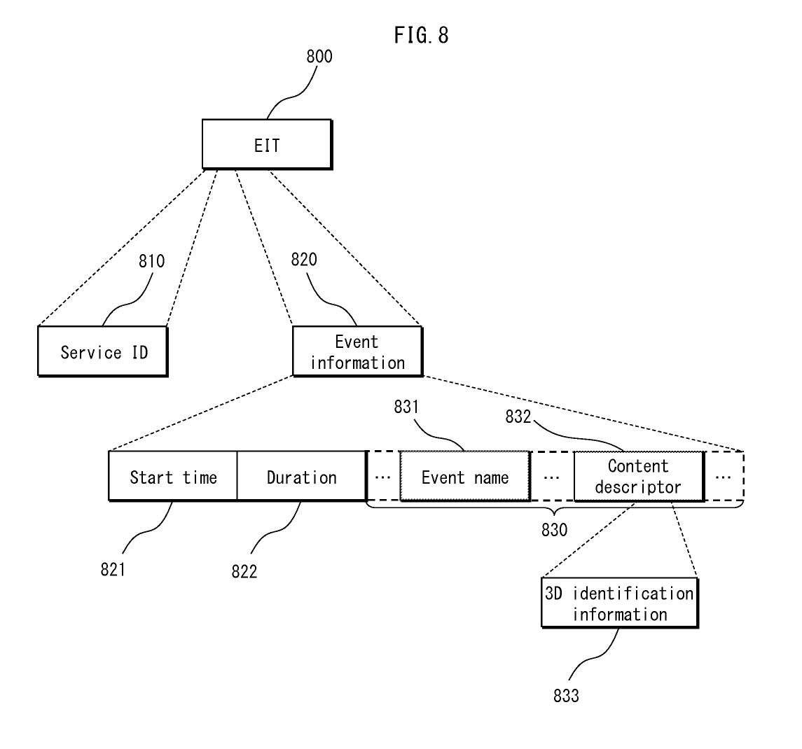

FIG. 8 is a schematic diagram showing the data structure of an EIT. Referring to FIG. 8, the EIT 800 includes a service ID 810 and event information 820. The service ID 810 indicates one assigned to the provider or broadcasting station of the broadcast stream containing the EIT 800. The event information 820 includes a start time 821, a duration 822, and descriptors 830 of each broadcast content. The start time 821 shows the date and time at which the broadcast content starts to be broadcast. The duration 822 shows the length of the time period during which the broadcast content continues to be broadcast. The descriptors 830 are information about details of the broadcast content, and each consist of two or more items in general. The items include an event name 831 and a content descriptor 832. The event name 831 includes text data representing the title and subtitle of the broadcast content. The content descriptor 832 includes information showing the genre of the broadcast content, and appendix information thereof. The appendix information includes 3D identification information 833 indicating that the broadcast content contains 3D video images.

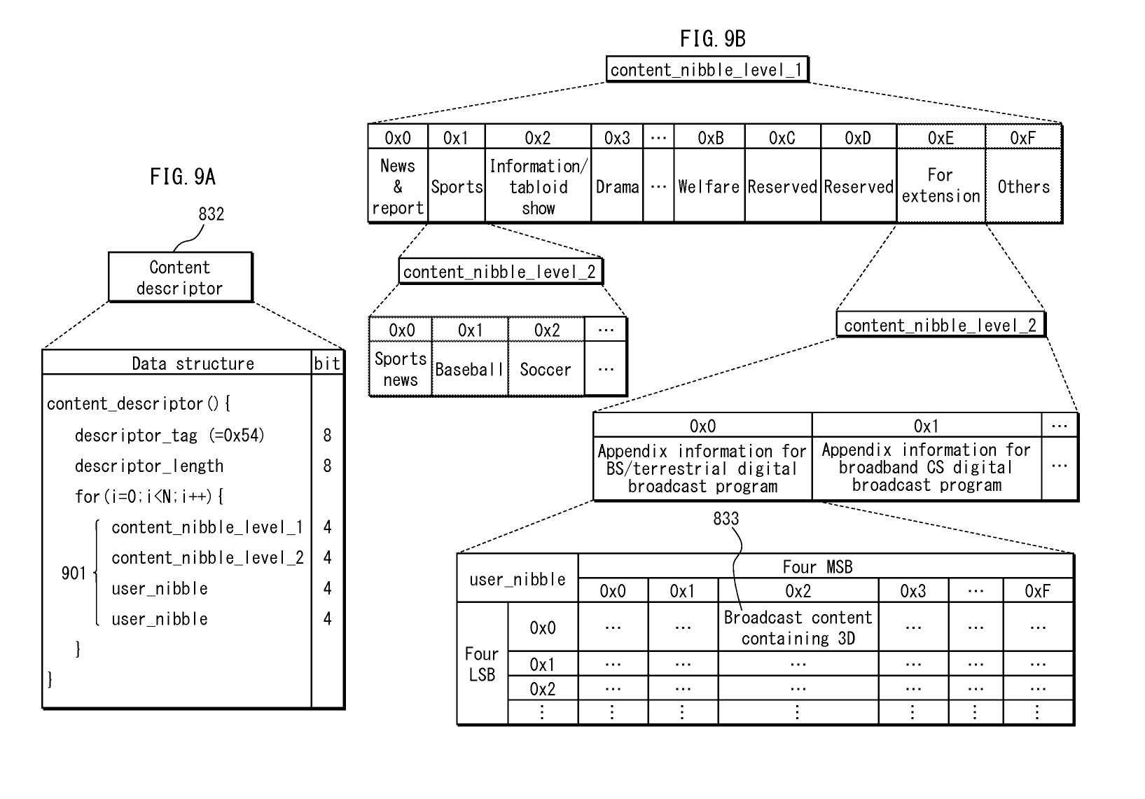

FIG. 9A is a schematic diagram showing the data structure of a content descriptor stipulated by the ARIB standards. Referring to FIG. 9A, the content descriptor (content_descriptor( )) 832 includes a tag (descriptor tag), a length (descriptor_length), and content genre information 901. The tag indicates a hexadecimal value 0x54 indicating that the descriptor belongs to content ones. The length shows the number of bits constituting the entirety of the content descriptor 832. The content genre information 901 is 16-bit data. Its upper eight bits (content_nibble_level_1 and content_nibble_level_2) indicate one of hexadecimal values individually assigned to genres of broadcast content, while its lower eight bits (user_nibble) do one of hexadecimal values individually assigned to appendix information of the genres.

FIG. 9B is a schematic diagram showing the data structure of the content genre information 901 stipulated by the ARIB standards. The hexadecimal values represented by the upper four bits of the content genre information 901 (content_nibble_level 1) include 0x0 to 0xB that are separately assigned to large classifications of genres of broadcast content, such as “news, report,” “sports,” and so on. The hexadecimal values 0xC and 0xD are reserved for future genre addition. The hexadecimal value 0xF is assigned to broadcast content that hardly fits into any of the genres assigned the hexadecimal values 0x0 to 0xB. The hexadecimal value 0xE is assigned to extension information. The extension information indicates that the lower eight bits (user nibble) of the content genre information 901 are assigned to the appendix information. The hexadecimal value represented by the middle four bits (content_nibble_level_2) of the content genre information 901 is assigned to one of middle classifications of genres; each of the large classifications is further divided into the middle ones. For the large classification “sports,” which is assigned the hexadecimal value 0x1 represented by the upper four bits (content_nibble_level_1), the hexadecimal values 0x0, 0x1, and 0x2 represented by the middle four bits (content_nibble_level_2) are, for example, assigned to “sports news,” “baseball,” and “soccer,” respectively. For the extension information, the hexadecimal value represented by the middle four bits (content_nibble_level_2) indicates the type of the appendix information. For example, the value 0x0 is assigned to appendix information for BS/terrestrial digital broadcast program. The lower eight bits (user_nibble) of the content genre information 901 indicates details of the appendix information. In particular, the four-digit hexadecimal value 0xE020 represented by the content genre information 901 is assigned to the 3D identification information 833.

Content descriptors stipulated by the DVB standards only differ from the ones shown in FIG. 9A in that the lower eight bits of the content genre information 901 is termed “user-byte” instead of “user-nibble.” In addition, content genre information stipulated by the DVB standards differs from the one shown in FIG. 9B in details of each classification assigned one of the hexadecimal values. Of the content genre information stipulated by the DVB standards, the hexadecimal values 0xF000 to 0xFFFF can be defined by users. Therefore, some of the hexadecimal values may be assigned to 3D identification information, like the content genre information 901 shown in FIG. 9B.

### [Configuration of Display Device]

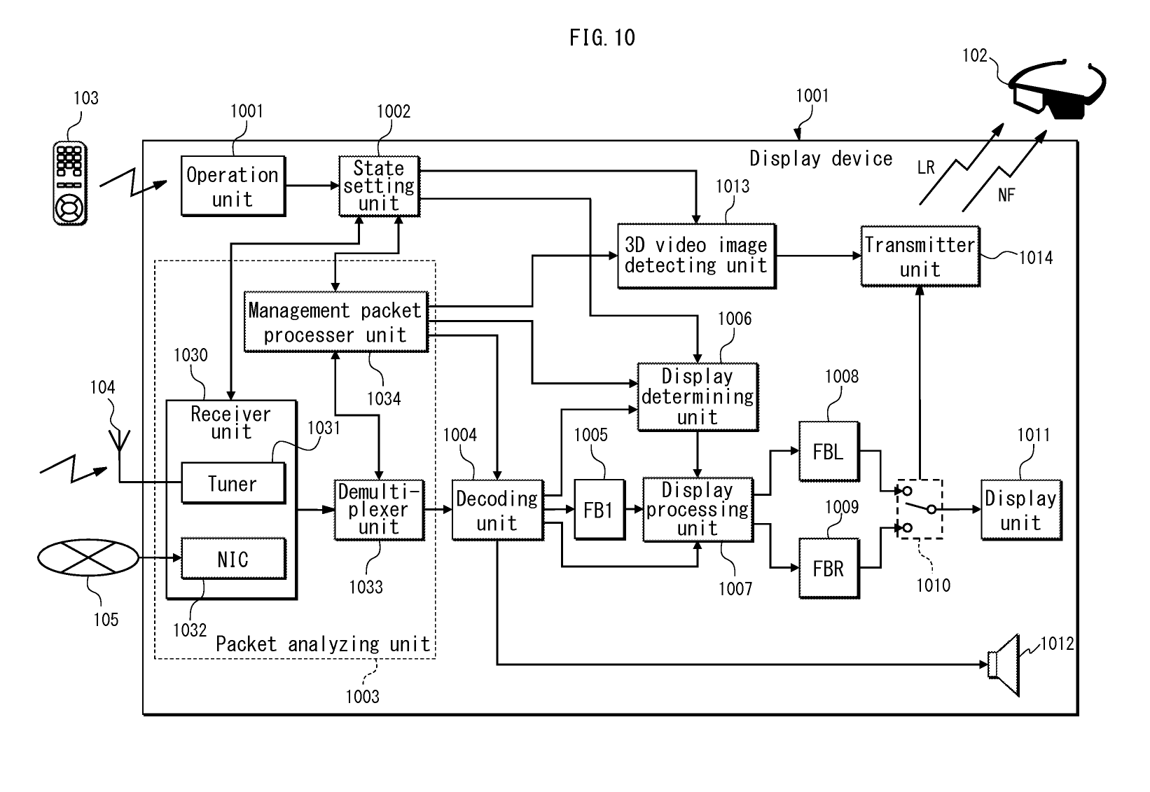

FIG. 10 is a block diagram showing the configuration of the display device 101. Referring to FIG. 10, the display device 101 includes an operation unit 1001, a state setting unit 1002, a packet analyzing unit 1003, a decoding unit 1004, a first frame buffer (FBI) 1005, a display determining unit 1006, a display processing unit 1007, a second frame buffer (FBL) 1008, a third frame buffer (FBR) 1009, a switch 1010, a display unit 1011, an audio output unit 1012 , a 3D video image detecting unit 1013, and a transmitter unit 1014.

The operation unit 1001 accepts an infrared or radio signal IR from the remote control 103, and then decodes the signal IR into identification information of a button. The operation unit 1001 also identifies a button pushed by a user from among buttons mounted on the front panel of the display device 101. The operation unit 1001 further specifies a function of the display device 101 assigned to the identified button on the remote control 103 or the front panel, and then requests the state setting unit 1002 to execute the specified function. Examples of the function include power-on and off, channel selection, volume control, selection of audio output scheme such as a surround sound one, selection of language, switching between 2D and 3D display modes, and programming of preselection of broadcast content to be watched.

The state setting unit 1002 functions according to predetermined software executed by a CPU implemented in the display device 101. The state setting unit 1002 includes registers to store parameters indicating the state of the display device 101 into them in response to requests from the operation unit 1001. Information indicated by the parameters includes identification information of a provider and broadcasting station, power-on and off of the display unit 1011, sound volume, types of language, audio output schemes, display modes, and information about preselection of broadcast content to be watched. The provider or broadcasting station shows one currently selected as the source of a broadcast stream to be received. The identification information of the provider or broadcasting station that has been selected immediately before power-off of the display unit 1011 remains in the registers of the state setting unit 1002 at the power-off. When the display unit 1011 is powered on again, video images of broadcast content distributed by the provider or broadcasting station appear on the screen.

The packet analyzing unit 1003 refers to the parameters stored in the registers of the state setting unit 1002 to receive a broadcast stream. The packet analyzing unit 1003 further separates and analyzes management packets from the broadcast stream. Specifically, the packet analyzing unit 1003 includes a receiver unit 1030, a demultiplexer unit 1033, and a management packet processer unit 1034.

The receiver unit 1030 first refers to the parameters stored in the registers of the state setting unit 1002 to specify the provider or broadcasting station currently selected as the source of a broadcast stream to be received. The receiver unit 1030 next receives the broadcast stream from the specified provider or broadcasting station to pass the broadcast stream to the demultiplexer unit 1033. Specifically, the receiver unit 1030 includes a tuner 1031 and a network interface card (NIC) 1032. The tuner 1031 receives a digital terrestrial television broadcasting wave or BS digital broadcasting wave through the antenna 104 to convert the broadcasting wave into a broadcast stream. The NIC 1032 receives via the network 105 a broadcast stream distributed by a cable television system or the like.

The demultiplexer unit 1033, together with the management packet processer unit 1034, the decoding unit 1004, the display determining unit 1006, the display processing unit 1007, and the switch 1010, is integrated onto a single chip. The demultiplexer unit 1033 reads a PID from each of TS packets constituting a broadcast stream, and based on the PID, either transmits the TS packet to one of the management packet processor unit 1034 and decoding unit 1004, or discard the TS packet. More specifically, the demultiplexer unit 1033, when receiving a new broadcast stream from the receiver unit 1030, first separates a TS packet containing a PAT from the broadcast stream to pass the TS packet to the management packet processor unit 1034. The demultiplexer unit 1033 next receives the PID of the PMT from the management packet processor unit 1034. In response, the demultiplexer unit 1033 separates the PMT from the broadcast stream to pass it to the management packet processor unit 1034. The demultiplexer unit 1033 subsequently receives the list of PIDs from the management packet processor unit 1034 to extract from the broadcast stream TS packets containing the PIDs shown on the list. From the extracted TS packets, the demultiplexer unit 1033 further passes those containing the management packets to the management packet processor unit 1034, and those containing a video or audio stream to the decoding unit 1004.

The management packet processor unit 1034 receives the TS packets containing the management packets from the demultiplexer unit 1033 to restore and analyze the management packets from the TS packets. The management packet processor unit 1034 further refers to the parameters stored in the registers of the state setting unit 1002 and the result of analyzing the management packets to identify the PIDs of TS packets to be extracted from the broadcast stream, then specifying the PIDs to the demultiplexer unit 1033. More specifically, when the demultiplexer unit 1033 receives the new broadcast stream from the receiver unit 1030, the management packet processor unit 1034 first receives the TS packet containing the PAT to restore the PAT from the TS packet. The management packet processor unit 1034 next analyzes the PAT to read the PID of the PMT and then pass it to the demultiplexer unit 1033. The management packet processor unit 1034 subsequently receives the TS packet containing the PMT from the demultiplexer unit 1033 to restore the PMT from the TS packet. The management packet processor unit 1034 further analyzes the PMT to create the list of PIDs of elementary streams. At this point, the management packet processor unit 1034 refers to the parameters stored in the registers of the state setting unit 1002 to identify languages, audio output schemes, and the likes, and based on them, selects elementary streams. The management packet processor unit 1034 then passes the list to the demultiplexer unit 1033.

The management packet processor unit 1034 reads information about a video stream to be displayed from the PMT to pass it to the display determining unit 1006. The management packet processor 1034 further reads information necessary for decoding respective elementary streams to pass it from the PMT to the decoding unit 1004.

The management packet processor unit 1034 also refers to the parameters stored in the registers of the state setting unit 1002 to detect power-off of the display unit 1011 or preselection of broadcast content to be watched. When the display unit 1011 is powered off, the management packet processor 1034 identifies as broadcast content to be displayed, one currently put on the air and contained in the broadcast stream that the receiver unit 1030 receives. In that case, the management packet processor unit 1034 causes the demultiplexer unit 1033 to separate from the broadcast stream TS packets containing the EIT that is assigned to the identified broadcast content. When the preselection has been programmed, the management packet processor 1034 identifies the broadcast content preselected as one to be displayed. In that case, the management packet processor unit 1034 causes the demultiplexer unit 1033 to separate from the broadcast stream TS packets containing the EIT that indicates a distribution schedule of broadcast contents. The management packet processer unit 1034 further restores and analyzes the EIT from these TS packets to read from the EIT the start time, duration, and content genre information of broadcast content to be displayed, to pass it to the 3D video image detecting unit 1013.

The decoding unit 1004 refers to the information necessary for decoding respective elementary streams, which is received from the management packet processer unit 1034, to individually restore video and audio streams from the TS packets received from the demultiplexer unit 1033. In particular, the decoding unit 1004 decodes pictures included in the video stream into video frames in the order of DTSs. The decoding unit 1004 writes the video frames into the FB1 1005 and transmits the audio stream to the audio output unit 1012. The decoding unit 1004 reads the video display information from the video stream to pass it to the display determining unit 1006, and also reads the PTS of each video frame to pass it to the display processing unit 1007.

The FB1 1005, FBL 1008, and FBR 1009 are composed of different memory areas of a RAM built in the display device 101. The frame buffers 1005, 1008, and 1009 can each store a video frame of the same size. When a plurality of video streams are to be decoded, the FB1 1005 is provided one for each video stream. In particular, when a broadcast stream includes a video stream containing 3D video images stored with the service compatible method, left- and right-view frames are separately written into different FB1s 1005. On the other hand, when a broadcast stream includes a video stream containing 3D video images stored with the frame compatible method, a single video frame stored in the FB1 1005 contains both left- and right-view frames stored in any pattern shown in FIGS. 6A-6D. The FBL 1008 is used to store a left-view frame, whereas the FBR 1009 is used to store a right-view frame.

The display determining unit 1006 specifies to the display processing unit 1007 at least one of the FBL 1008 and FBR 1009 as a destination where data is to be written, and also specifies one of the video frames stored in the FB1 1005 as data to be written. The display processing unit 1007 then writes the data specified by the display determining unit 1006 into the frame buffer specified thereby.

More specifically, the display determining unit 1006 first refers to the parameters stored in the registers of the state setting unit 1002 to check the display mode. When the parameters indicate the 2D display mode, the display determining unit 1006 designates the FBL 1008 only as the destination. When the parameters indicate the 3D display mode, the display determining unit 1006 designates both the FBL 1008 and FBR 1009 as the destinations.

The display determining unit 1006 subsequently uses the information received from the management packet processer unit 1034 to check whether the broadcast stream contains a 3D video stream or not.

When the broadcast stream does not contain any 3D video stream, the display determining unit 1006 designates to the display processing unit 1007 as an area within the FB1 1005 to be processed in data writing, the area specified by the cropping area information included in the video display information. In response, the display processing unit 1007 converts data residing in the area to one of the size indicated by the scaling information included in the video display information, and then writes it into the FBL 1008 at the time indicted by the PTS of the video frame. Furthermore, when the FBR 1009 is also designated as the destination, the display processing unit 1007 writes into the FBR 1009 the data to be written into the FBL 1008 at the same time when writing the data thereinto.

On the other hand, when the broadcast stream includes a 3D video stream, the display determining unit 1006 further checks whether the video stream employs the frame or service compatible method.

When the video stream employs the frame compatible method, the display determining unit 1006 first reads the 3D video format information from the information received from the management packet processer unit 1034. The display determining unit 1006 next refers to the 3D video format information to identify which of the patterns shown in FIGS. 6A-6D the video frame stored in the FB1 1005 has, and then notifies the display processing unit 1007 of an identified pattern. In response, the display processing unit 1007 first, based on the notified pattern, separates the video frame stored in the FB1 1005 into left- and right-view ones, and then expands them to their original sizes. The display processing unit 1007 next converts data residing in an area within the left-view frame into data of a size; the area is specified by the cropping area information, and the size is by the scaling information. The display processing unit 1007 then writes the converted data into the FBL 1008 at the time indicted by the PTS of the video frame. When the FBR 1009 is also designated as the destination, the display processing unit 1007 further converts data residing in an area within the right-view frame into data of a size; the area is specified by the cropping area information, and the size is by the scaling information. The display processing unit 1007 then writes the converted data into the FBR 1009 at the time indicted by the PTS of the video frame.

When the 3D video stream employs the service compatible method, the display determining unit 1006 notifies the display processing unit 1007 accordingly. In response, the display processing unit 1007 first converts data residing in an area within the left-view frame stored in the FB1 1005 into data of a size; the area is specified by the cropping area information, and the size is by the scaling information.

The display processing unit 1007 then writes the converted data into the FBL 1008 at the time indicted by the PTS of the video frame. When the FBR 1009 is also designated as the destination, the display processing unit 1007 further converts data residing in an area within the right-view frame stored in the FB1 1005 into data of a size; the area is specified by the cropping area information, and the size is by the scaling information. The display processing unit 1007 then writes the converted data into the FBR 1009 at the time indicted by the PTS of the video frame.

The switch 1010 transmits video frames from the FBL 1008 to the display unit 1011 at 60 fps when the display device 101 is in the 2D display mode. On the other hand, the switch 1010 transmits video frames alternately from the FBL 1008 and FBR 1009 to the display unit 1011 at 120 fps when the display device 101 is in the 3D display mode. In this case, the switch 1010 further notifies the transmitter unit 1014 of when the switch 1010 transmits left- and right-view frames from the FBL 1008 and FBR 1009, respectively.

The display unit 1011 includes a display panel. Each time receiving a video frame from the switch 1010, the display unit 1011 adjusts the luminance of each pixel of the display panel according to pixel data constituting the video frame. Thus, video images represented by the video frame appear on the display panel.

The audio output unit 1012 includes a speaker and drives it according to the audio stream. Thus, sounds represented by the audio stream are reproduced by the speaker.

The 3D video image detecting unit 1013 functions according to predetermined software executed by the CPU implemented in the display device 101. The 3D video image detecting unit 1013 determines from the content genre information whether broadcast content to be displayed contains 3D video images or not. More specifically, the 3D video image detecting unit 1013 checks whether or not the content genre information includes the 3D identification information, for example, the hexadecimal value 0xE020 according to the ARIB standards. When the content genre information includes the 3D identification information, the 3D video image detecting unit 1013 requests the transmitter unit 1014 to transmit the notification signal NF.

When broadcast content to be displayed is one currently put on the air, the 3D video image detecting unit 1013 computes the end time of the broadcast content from the start time and duration thereof, and then monitors whether current time reaches the end time. The 3D video image detecting unit 1013 also monitors the state of power of the display unit 1011 through parameters stored in the registers of the state setting unit 1002. When current time has reached the end time before the display unit 1011 is powered on, the 3D video image detecting unit 1013 causes the management packet processer unit 1034 to identify broadcast content to be subsequently put on the air as new broadcast content to be displayed. When the display unit 1011 is powered on before the end time with the 3D video image detecting unit 1013 requesting the transmitter unit 1014 to transmit the notification signal NF, the 3D video image detecting unit 1013 causes the transmitter unit 1014 to stop transmitting the notification signal NF. Thus, the 3D glasses 102 stop the operating shown in any of FIGS. 3A-3D.

When broadcast content to be displayed is one preselected to be watched, the 3D video image detecting unit 1013 monitors the state of power of the display unit 1011 and the source of a broadcast stream to be received, as well as current time, through parameters stored in the registers of the state setting unit 1002. When current time has reached the start time of the broadcast content to be displayed, the display unit 1011 has been powered on, and the source of the broadcast stream to be received matches with that of the broadcast content, the 3D video image detecting unit 1013 acknowledges the start of displaying the broadcast content. When acknowledging the start with requesting the transmitter unit 1014 to transmit the notification signal NF, the 3D video image detecting unit 1013 causes the transmitter unit 1014 to stop transmitting the notification signal NF. Thus, the 3D glasses 102 stop the operating shown in any of FIGS. 3A-3D when video images of the preselected broadcast content appear on the screen of the display device 101.

The transmitter unit 1014 is equivalent to the one 112 shown in FIG. 1, and transmits the left-right signal LR or notification signal NF to the 3D glasses 102. The transmitter unit 1014 employs a wireless communication method conforming to IrDA. Other wireless communication methods may be alternatively employed, such as one using electric waves at radio frequency (RF) bands, one conforming to IEEE 802.11, and one according to Bluetooth™. When the display device 101 is in the 2D display mode, the transmitter unit 1014 does not transmit the left-right signal LR. When the display device 101 is in the 3D display mode, the transmitter unit 1014 changes the left-right signal LR with the timing notified by the switch 1010. In response to a request from the 3D video image detecting unit 1013, the transmitter unit 1014 further transmits the notification signal NF to the 3D glasses 102.

### [Operation of Display Device to Transmit Notification Signal]

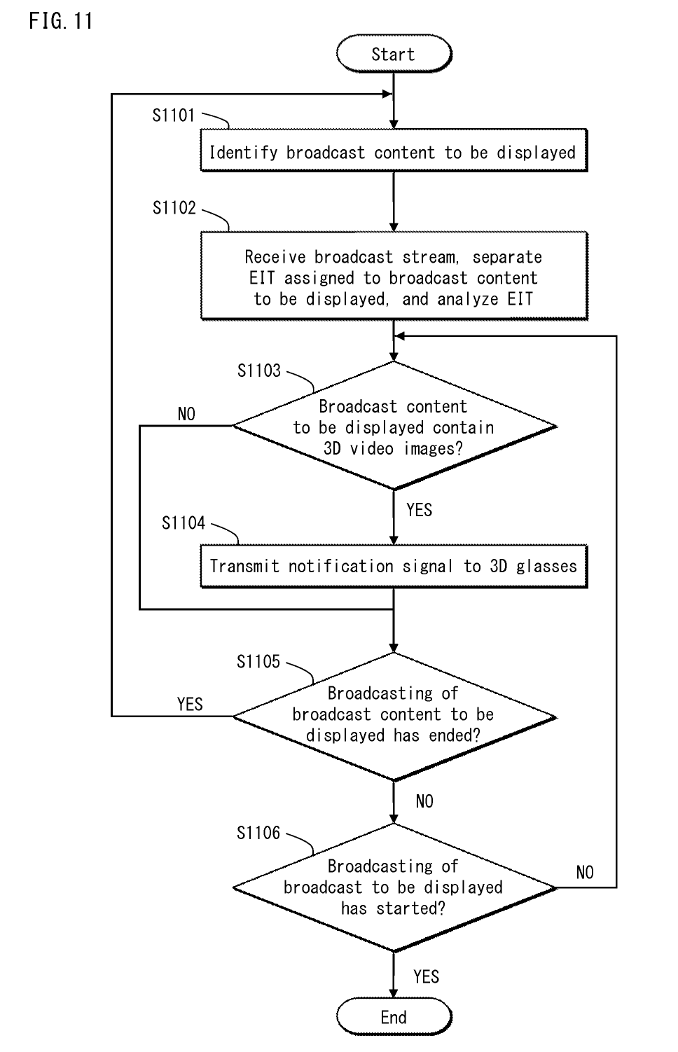

FIG. 11 is a flowchart of operation of the display device 101 to transmit the notification signal NF when broadcast content to be displayed is one currently put on the air. This operation starts at power-off of the display unit 1011.

In step S1101, the management packet processer unit 1034 refers to the parameters stored in the registers of the state setting unit 1002 to detect the power-off of the display unit 1011. The management packet processor 1034 further identifies as broadcast content to be displayed, one currently put on the air and included in the broadcast stream that the receiver unit 1030 receives. Thereafter, the process proceeds to step S1102.

In step S1102, the receiver unit 1030 refers to the parameters stored in the registers of the state setting unit 1002 to identify the source of a broadcast stream to be received, and then receives the broadcast stream from the source to pass it to the demultiplexer unit 1033. The management packet processor unit 1034 causes the demultiplexer unit 1033 to separate from the broadcast stream TS packets containing an EIT assigned to the broadcast content to be displayed. The management packet processer unit 1034 further restores and analyzes the EIT from these TS packets, and thus reads from the EIT the start time, duration, and content genre information of the broadcast content to be displayed to pass them to the 3D video image detecting unit 1013. Thereafter, the process proceeds to step S1103.

In step S1103, the 3D video image detecting unit 1013 checks whether the content genre information includes the 3D identification information or not. When the content genre information includes the 3D identification information, the process proceeds to step S1104. When the content genre information does not include the 3D identification information, the process proceeds to step S1105.

In step S1104, the content genre information includes the 3D identification information, and thus the 3D video image detecting unit 1013 requests the transmitter unit 1014 to transmit the notification signal NF. In response to the request, the transmitter unit 1014 transmits the notification signal NF to the 3D glasses 102. Thereafter, the process proceeds to step S1105.

In step S1105, the 3D video image detecting unit 1013 computes the end time of the broadcast content to be displayed from the start time and duration thereof to monitor whether current time reaches the end time. When current time has reached the end time, the process is repeated from step S1101. Thus, broadcast content to be subsequently put on the air is specified as new broadcast content to be displayed. On the other hand, when current time has not yet reached the end time, the process proceeds to step S1106.

In step S1106, the 3D video image detecting unit 1013 monitors the state of power of the display unit 1011 through the parameters stored in the registers of the state setting unit 1002. When the display unit 1011 is powered on, the process ends. Since the transmitter unit 1014, if transmitting the notification signal NF, stops it, the 3D glasses 102 stop the operating shown in any of FIGS. 3A-3D. On the other hand, when the display unit 1011 remains powered off, the process is repeated from step S1103.

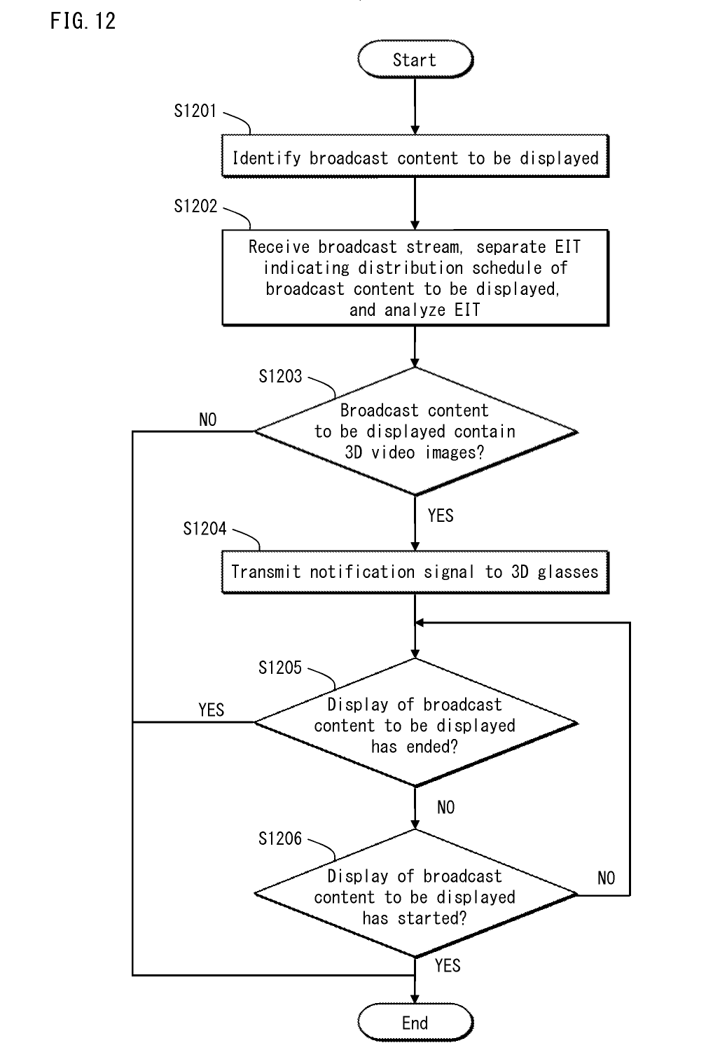

FIG. 12 is a flowchart of operation of the display device 101 to transmit the notification signal NF when broadcast content to be displayed is one preselected to be watched. This operation starts at programming of preselection of broadcast content to be watched on the display device 101, or a predetermined length of time before the preselected broadcast content starts to be put on the air.

In step S1201, the management packet processer unit 1034 refers to the parameters stored in the registers of the state setting unit 1002 to detect the preselection. The management packet processor unit 1034 further identifies specifies the broadcast content preselected as one to be displayed. Thereafter, the process proceeds to step S1202.

In step S1202, the receiver unit 1030 refers to the parameters stored in the registers of the state setting unit 1002 to identify the source of the broadcast stream to be received, and then receives the broadcast stream from the source and passes it to the demultiplexer unit 1033. The management packet processor unit 1034 causes the demultiplexer unit 1033 to separate from the broadcast stream TS packets containing an EIT indicating a distribution schedule of broadcast contents. The management packet processer unit 1034 further restores and analyzes the EIT from the TS packets, and then reads from the EIT the start time, duration, and content genre information of the broadcast content to be displayed to pass them to the 3D video image detecting unit 1013. Thereafter, the process proceeds to step S1203.

In step S1203, the 3D video image detecting unit 1013 checks whether the content genre information includes the 3D identification information or not. When the content genre information includes the 3D identification information, the process proceeds to step S1204. When the content genre information does not include the 3D identification information, the process ends.

In step S1204, the content genre information includes the 3D identification information, and thus the 3D video image detecting unit 1013 requests the transmitter unit 1014 to transmit the notification signal NF. In response to the request, the transmitter unit 1014 transmits the notification signal NF to the 3D glasses 102. Thereafter, the process proceeds to step S1205.

In step S1205, the 3D video image detecting unit 1013 monitors the state of power of the display unit 1011 and the source of a broadcast stream to be received, as well as current time, through the parameters stored in the registers of the state setting unit 1002. When current time has reached the start time of the broadcast content to be displayed, the display unit 1011 has been powered on, and the source of the broadcast stream to be received matches with that of the broadcast content to be displayed, the 3D video image detecting unit 1013 acknowledges the start of displaying the broadcast content to be displayed. Then, the process ends. As a result, the 3D glasses 102 stop the operating shown in any of FIGS. 3A-3D when video images of the preselected broadcast content appear on the screen of the display device 101. On the other hand, when the 3D video image detecting unit 1013 does not acknowledge the start of displaying the broadcast content to be displayed, the process proceeds to step S1206.

In step 51206, the 3D video image detecting unit 1013 computes the end time of the broadcast content to be displayed from the start time and duration thereof, and then monitors whether current time reaches the end time or not. When current time has reached the end time, the process ends. Thus, the transmitter unit 1014 stops transmitting the notification signal NF, and thus the 3D glasses 102 stop the operating shown in any of FIGS. 3A-3D. On the other hand, when current time has not yet reached the end time, the process is repeated from step S1205.

### [Configuration of 3D Glasses]

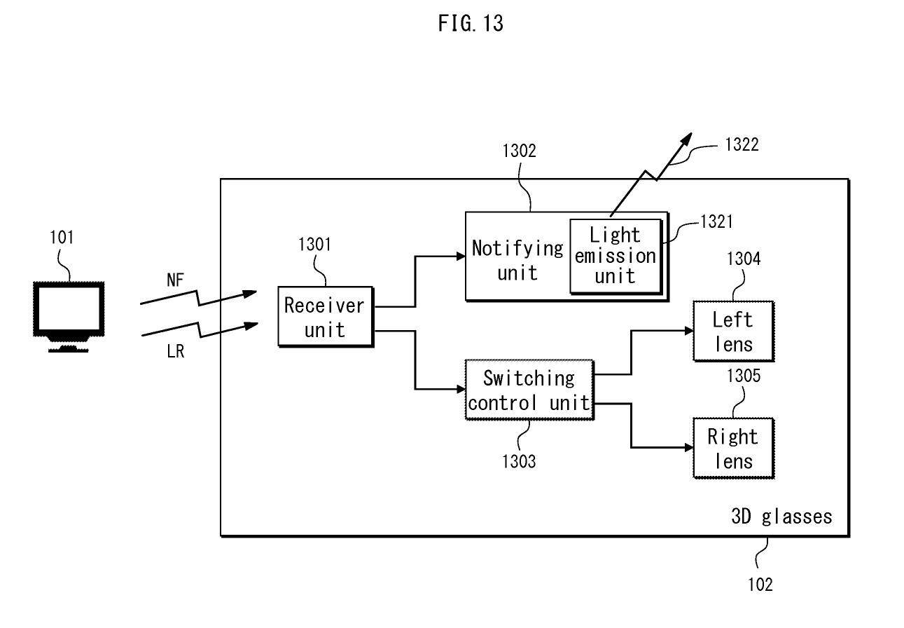

FIG. 13 is a block diagram showing an example of the configuration of the 3D glasses 102. Referring to FIG. 13, the 3D glasses 102 include a receiver unit 1301, a notifying unit 1302, a switching control unit 1303, a left lens 1304, and a right lens 1305.

The receiver unit 1301 receives the left-right signal LR and the notification signal NF from the display device 101. The receiver unit 1301 employs the same wireless communication method as the transmitter unit 1014 of the display device 101. The receiver unit 1301 detects changes of the left-right signal LR, and then notifies the switching control unit 1303 of the changes. In addition, the receiver unit 1301 sends an instruction to the notifying unit 1302, each time receiving the notification signal NF.

In response to the instruction from the receiver unit 122, the notifying unit 1302 operates to urge a viewer to use the 3D glasses 102. In the example shown in

FIG. 13, the notifying unit 1302 includes a light emission unit 1321 such as an LED, and thus emits visible light 1322 as the above-described operating . The light emission unit 1321 keeps the light 1322 at a constant brightness, causes it to periodically blink, or changes its brightness or color according to a specific pattern.

Instead of the light emission unit 1321, the notifying unit 1302 may include a sound generating unit such as a small speaker, or a vibrator unit with a vibratile member built in. The notifying unit may generate sounds or vibrations in response to the instruction from the receiver unit 122; this serves as the operating to urge a viewer to use the 3D glasses.

The switching control unit 1303 identifies from the pattern of the changes of the left-right signal LR, whether video images currently displayed on the screen of the display device 101 are left- or right-view ones. While the left- and right-view images are displayed, the switching control unit 1303 further sends instructions to the left lens 1304 and the right lens 1305, respectively, synchronously with the changes of the left-right signal LR. The left lens 1304 and right lens 1305 are respectively equivalent to the left lens 121L and the right lens 121R shown in FIG. 1; each of the lenses is composed of a liquid crystal display panel. Each of the lenses 1304 and 1305 operates in the normally white mode; its entirety transmits light until receiving an instruction from the switching control unit 1303, and then blocks light in response to the instruction.

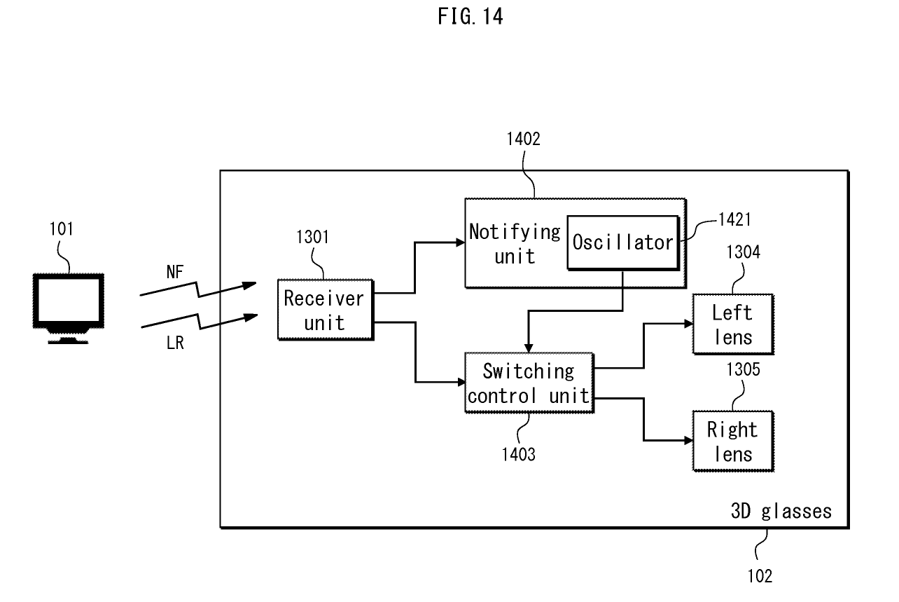

FIG. 14 is a block diagram showing another example of the configuration of the 3D glasses. The configuration shown in FIG. 14 differs from that shown in FIG. 13 in that the notifying unit 1402 includes an oscillator 1421 instead of the light emission unit 1321, and the switching control unit 1403 sends an instruction to the lenses 1304 and 1305 in response to a periodic signal from the oscillator 1421. Other components are the same as those shown in FIG. 13. Therefore, details of the same components can be found in the explanation about FIG. 13.

Referring to FIG. 14, the notifying unit 1402 includes the oscillator 1421. The oscillator 1421 includes a quartz resonator, and thus generates a periodic signal at a frequency sufficiently lower than that at which the display device 101 switches between left- and right-view video frames. The notifying unit 1402 sends the periodic signal to the switching control unit 1403 in response to an instruction from the receiver unit 1301 that has received the notification signal NF. Synchronously with the periodic signal, the switching control unit 1403 sends instructions to the lenses 1304 and 1305 alternately. Thus, the lenses 1304 and 1305 alternately block light at the same frequency as that of the periodic signal. As a result, the light passing through the lenses 1304 and 1305 changes its brightness at a perceptible rate, thus seen to flicker by a viewer. That is, the flicker is recognized by the viewer as the operating to urge him or her to use the 3D glasses.

### [Advantageous Effects of Embodiment 1]

In the display device 101 according to Embodiment 1 of the present invention, first of all, the packet analyzing unit 1003 refers to parameters stored in the registers of the state setting unit 1002 to identify broadcast content to be displayed. Next, the packet analyzing unit 1003 analyzes an EIT contained in a broadcast stream. Based on the result of analyzing, the 3D video image detecting unit 1013 determines whether the broadcast content to be displayed contains 3D video images or not. The determination is made before the display device 101 displays 3D video images contained in the broadcast content to be displayed. When the broadcast content to be displayed contains 3D video images, the 3D video image detecting unit 1013 causes the transmitter unit 1014 to transmit the notification signal NF to the 3D glasses 102. In response to the notification signal NF, the 3D glasses 102 operate to urge a viewer to use the 3D glasses as shown in any of FIGS. 3A-3D. Thus, the 3D video system according to Embodiment 1 of the present invention enables the 3D glasses 102 to operate to urge the viewer to use the 3D glasses 102 before the display device 101 displays 3D video images contained in broadcast content. This protects the viewer from unintentionally watching the 3D video images with an unaided eye at power-on of the display unit 1011 or at the start of displaying broadcast content preselected to be watched.

### [Modifications]

(A) The display device 101 according to Embodiment 1 of the present invention is a liquid crystal display. Alternatively, the display device of the present invention may be another type of flat panel display such as a plasma display, an organic EL display, etc., or a projector.

(B) The 3D glasses 102 according to Embodiment 1 of the present invention are a type of shutter glasses. Alternatively, the 3D glasses of the present invention may be those with left and right lenses separately coated with polarization films having different polarization directions, or those with left and right lenses having different transmission spectra. For the former, the display device displays left- and right-view video images separately, using lights with different polarization directions. For the latter, the display device displays left- and right-view video images separately, using lights with different spectra. In either case, the left lens selectively transmits the left-view video images, and the right lens does the right-view ones.

(C) The operating of the notifying unit of the 3D glasses 102 is never limited to one shown in any of FIGS. 3A-3D as long as it is physical and perceptible. The operating may be creating a breeze, generating heat, releasing an aroma, or the like. In addition, the notifying unit may operate with use of an existing mechanism incorporated in the 3D glasses 102, as shown in FIG. 3D and FIG. 14. Besides the example shown in FIG. 14, a surround sound speaker, when embedded in the 3D glasses, may double as the sound generating unit of the notifying unit. A vibrator, when embedded in the 3D glasses to vibrate in conjunction with 3D video images to enhance realism for them, may double as the vibrator unit of the notifying unit.

(D) A picture contained in one of the PES packets 411 shown in FIG. 4 is a single video frame encoded as a whole. The picture may alternatively be a single encoded field.

(E) One or more of the demultiplexer unit 1033, management packet processer unit 1034, decoding unit 1004, display determining unit 1006, display processing unit 1007, and switch 1010 shown in FIG. 10 may be implemented on one chip, but the other units may be on another. One or more of them may function according to software executed by the CPU of the display device 101. One or more of the FB1 1005, FBL 1008, and FBR 1009 may be included in one memory element, but the other frame buffers may be in another.

(F) In the configuration shown in FIG. 10, the management packet processer unit 1034 reads the 3D video format information from the PMT to pass it to the display determining unit 1006. Alternatively, the decoding unit 1004 may read 3D video format information from the supplementary data in the video stream to pass it to the display determining unit 1006.

(G) According to Embodiment 1 of the present invention, the notification signal NF is transmitted from the display device 101 to the 3D glasses 102 when the 3D video image detecting unit 1013 detects that the EIT 800 shown in FIG. 8 includes the 3D identification information 833. Alternatively, the notification signal NF may be transmitted from the display device 101 to the 3D glasses 102 when the 3D video image detecting unit 1013 detects from a PMT that a broadcast stream includes a 3D video stream. More specifically, first the 3D video image detecting unit 1013 receives information about video streams, which is included in the PMT, from the management packet processer unit 1034. Then, the 3D video image detecting unit 1013 checks whether or not the information includes one indicating a method of storing 3D video images. When the information indicates either a frame or service compatible method, the 3D video image detecting unit 1013 requests the transmitter unit 1014 to transmit the notification signal NF.

When the 3D video format information is included in the supplementary data of the 3D video stream, the decoding unit 1004 may read the supplementary data from the video stream to pass it to the 3D video image detecting unit 1013. The 3D video image detecting unit 1013 checks whether the supplementary data includes 3D video format information or not, and if does, then it requests the transmitter unit 1014 to transmit the notification signal NF.

(H) According to Embodiment 1 of the present invention, the source of broadcast content to be displayed is a provider or broadcasting station that has been selected immediately before power-off of the display unit 1011, or the source of broadcast content preselected to be watched. Alternatively, a source of broadcast content to be displayed may be a provider or broadcasting station preset to the registers of the state setting unit 1002 such that the provider or broadcasting station is to be selected at each power-on of the display unit 1011. In addition, whether broadcast content distributed by a specific provider or broadcasting station contains 3D video images or not may be determined while another broadcast content is distributed from a different provider or broadcasting station and its video images are displayed on a screen. Furthermore, while video images of currently on-air broadcast content are displayed on a screen, whether the subsequent broadcast content contains 3D video images or not may be determined.

(I) According to the flowcharts shown in FIGS. 11 and 12, the display device 101 prevents transmission of the notification signal NF at the start of displaying video images of broadcast content to be displayed, and thus the notifying unit of the 3D glasses 102 stops the operating. Alternatively, a viewer may cause the receiver unit of the 3D glasses 102 to stop receiving the notification signal, by operating a button or the like mounted on the 3D glasses 102. When the display device 101 and the 3D glasses 102 can communicate bidirectionally, a notification of a viewer wearing the 3D glasses 102 may be sent from the 3D glasses 102 to the display device 101. A viewer may manually cause the 3D glasses 102 to generate the notification, or the 3D glasses 102 may automatically generate it when detecting a viewer wearing the 3D glasses 102 by a glasses usage sensor. In response to the notification, the display device 101 stops transmitting the notification signal. Consequently, the notifying unit of the 3D glasses 102 stops the operating. In those cases, the notifying unit of the 3D glasses 102 continues the operating regardless of whether video images of broadcast content to be displayed appear on a screen or not. Therefore, a viewer, even if failing to find the 3D glasses 102 before the start of displaying the video images, can still search them with the help of the operating of their notifying unit. Furthermore, the display device 101, when set in the 2D display mode, may continue to transmit the notification signal after the start of displaying video images of broadcast content to be displayed. Thus, the operating of the notifying unit of the 3D glasses 102 can help a viewer realize that video images currently displayed on the screen are to be visible as 3D ones.

(J) In the configuration shown in FIG. 14, the oscillator 1421 may generate the periodic signal at the same frequency, e.g., 120 fps, as the display device 101 switches between left- and right-view video frames. In that case, the receiver unit 1301 receives the left-right signal LR at predetermined time intervals, and the switching control unit 1303 synchronizes the periodic signal with the left-right signal LR. Thus, the switching control unit 1303 enables the lenses 1304 and 1305 to alternately block light synchronously with the periodic signal, even while the receiver unit 1301 does not receive the left-right signal LR. As a result, the receiver unit 1301 can save power required for receiving the left-right signal LR.

(K) According to Embodiment 1 of the present invention, the display device 101 or the remote control 103 may be equipped with a structure to store the 3D glasses 102. Furthermore, the structure may have a functional unit for charging the 3D glasses 102 stored therein. In addition, the structure may have a functional unit for connecting the 3D glasses 102 to an external network. In this case, the 3D glasses 102 may update their firmware via the network.

### Embodiment 2

### [Display Device]

A display device according to Embodiment 2 of the present invention differs from that according to Embodiment 1 in incorporating an identifier of a user or a pair of 3D glasses into the notification signal when broadcast content to be displayed is one preselected to be watched. Other components of the display device according to Embodiment 2 are similar to those of Embodiment 1, including those shown in FIG. 10. Therefore, details of the components can be found in the description about Embodiment 1.

The user operates the remote control 103 to input information about preselection into the display device 101. The state setting unit 1002 accepts the information via the operation unit 1001, and accordingly sets parameters representing the information to the registers. The state setting unit 1002 further causes the display unit 1011 to display a message. The message shows a content prompting a user to input his or her own identifier when the user has programmed the preselection, or an identifier of the 3D glasses 102 when the user should use them. When the user operates the remote control 103 to input the identifier of himself, herself, or the 3D glasses to the display device 101, the state setting unit 1002 accepts the identifier via the operation unit 1001, and then sets it to the registers.

The management packet processer unit 1034 refers to the parameters stored in the registers of the state setting unit 1002 to detect the preselection programmed Then, the management packet processor 1034 identifies broadcast content preselected as one to be displayed. The management packet processor unit 1034 further causes the demultiplexer unit 1033 to separate from the broadcast stream TS packets containing the EIT indicating a distribution schedule of broadcast contents, and then restores and analyzes the EIT from the TS packets. Thereafter, from the EIT, the start time, duration, and content genre information of the broadcast content to be displayed are read to be sent to the 3D video image detecting unit 1013. The 3D video image detecting unit 1013 checks whether the content genre information includes the 3D identification information or not. When the content genre information includes the 3D identification information, the 3D video image detecting unit 1013 refers to the parameters stored in the registers of the state setting unit 1002 to read the identifier of the user or the 3D glasses indicated by the parameters. After that, the 3D video image detecting unit 1013 passes the identifier to the transmitter unit 1014, and in parallel requests the transmitter unit 1014 to transmit the notification signal NF. In response to the request, the transmitter unit 1014 incorporates the identifier into the notification signal NF, and then transmits the notification signal NF to the 3D glasses. [3D Glasses]

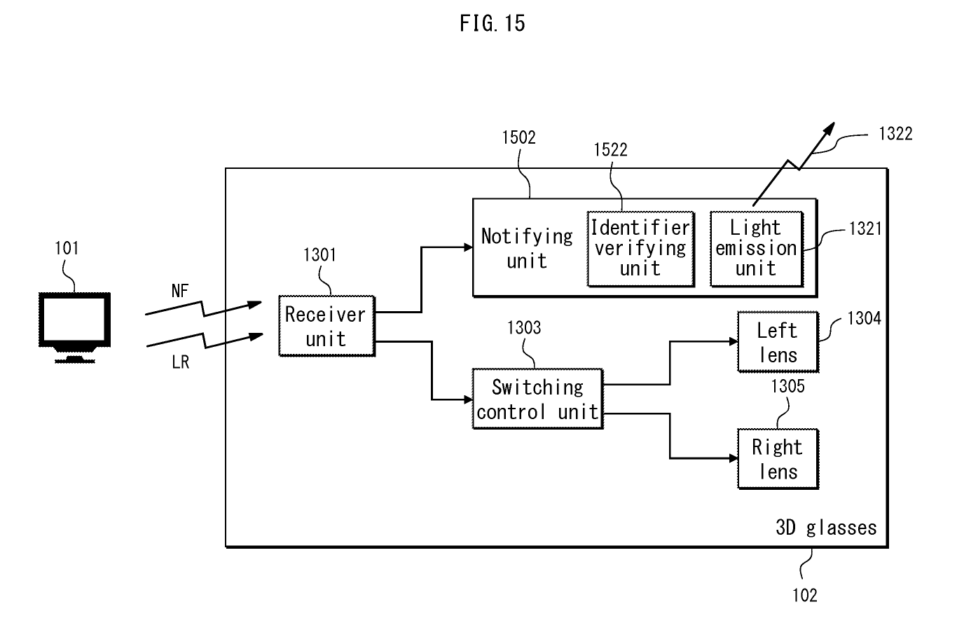

FIG. 15 is block diagram showing the configuration of a pair of 3D glasses 1500 according to Embodiment 2 of the present invention. The configuration shown in FIG. 15 differs from that shown in FIG. 13 in its notifying unit 1502 including an identifier verifying unit 1522. Other components are similar to those shown in FIG. 13. Therefore, details of the similar components can be found in the explanation about FIG. 13.

The receiver unit 1301, each time receiving the notification signal NF, sends an instruction to the notifying unit 1502, and in parallel reads the identifier of a user or 3D glasses from the notification signal NF to pass it to the notifying unit 1502. The identifier verifying unit 1522 previously stores the identifier of a user who owns the 3D glasses 1500 including the identifier verifying unit 1522, or the identifier of the 3D glasses 1500. When receiving the identifier from the receiver unit 1301, the identifier verifying unit 1522 compares the identifier with one stored therein. When the identifiers match with each other, the identifier verifying unit 1522 permits the light emission unit 1321 to be activated. Thus, the light emission unit 1321 emits visible light 1322 in response to an instruction from the receiver unit 1301. When the identifier received from the receiver unit 1301 does not match with the stored one, the identifier verifying unit 1522 inhibits activation of the light emission unit 1321. Thus, the light emission unit 1321 never emits the visible light 1322 regardless of an instruction from the receiver unit 1301.

In FIG. 15, the notifying unit 1302 includes the light emission unit 1321 to use the light 1322 to urge a viewer to use the 3D glasses 1500. Alternatively, the notifying unit 1302 may include a sound generating unit or a vibrator unit to use sounds or vibrations to urge a viewer to use the 3D glasses 1500. In addition, the notifying unit 1302 may include an oscillator 1421, like the configuration shown in FIG. 14, and then use it to cause the left lens 1304 and the right lens 1305 to alternately block light. In this case, both the lenses 1304 and 1305 flicker due to their transmitted lights, and thus the flickering can urge a viewer to use the 3D glasses 1500.

### [Advantageous Effects of Embodiment 2]

The 3D video system according to Embodiment 2 of the present invention may include two or more pairs of the 3D glasses 1500 available for the single display device 101. Furthermore, each pair of the 3D glasses 1500 may be assigned to a different user, and its function such as the transparency of the lenses 1304 and 1305 may be customized specially for the user. In addition, the 3D glasses 1500 with lenses of different sizes or the likes may be assigned to different users to fit their respective interpupillary distances. This 3D video system can use an identifier that a user entered into the display device 101 when preselecting broadcast content to be watched, to identify a specific pair of the 3D glasses 1500 that the user should use; thus, the 3D video system selectively enables the notifying unit of the specific pair of the 3D glasses 1500 to operate to urge a viewer to use the 3D glasses 1500. Accordingly, the user who programmed the preselection can wear a proper pair of the 3D glasses 1500 assigned to him or her before the display device 101 displays video images of the preselected broadcast content.

### <<Reference Embodiment 1>>

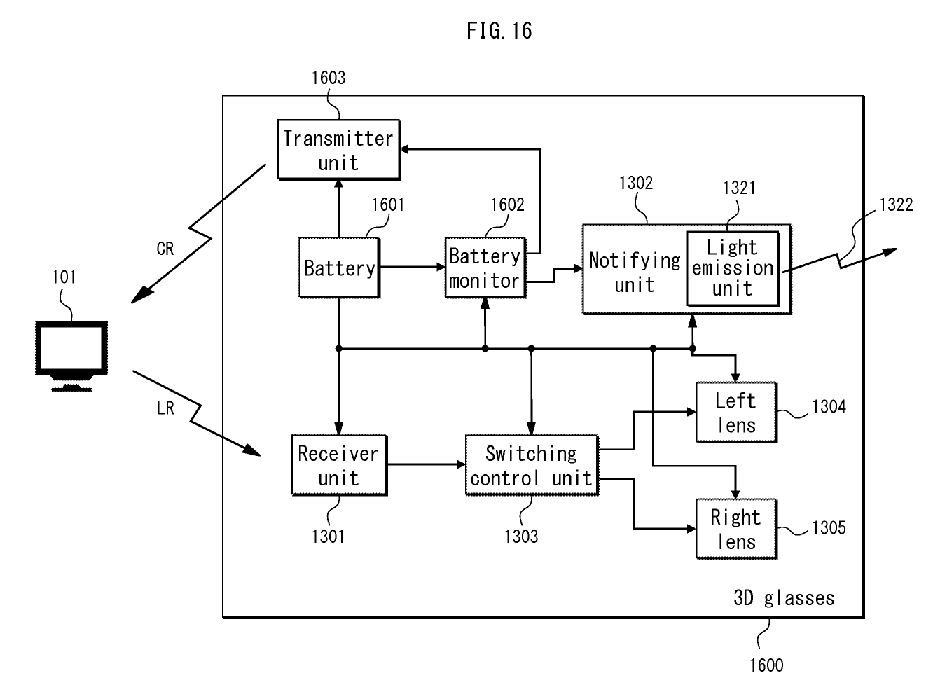

FIG. 16 is a block diagram showing the structure of a pair of 3D glasses 1600 according to Reference Embodiment 1. The structure shown in FIG. 16 differs from that shown in FIG. 13 in that a battery 1601, a battery monitor 1602, and a transmitter unit 1603 are included. Other components are the same as those shown in FIG. 13. Therefore, details of the same components can be found the explanation about FIG. 13.

The battery 1601 is a primary or secondary battery, such as a button battery, and supplies power to the other components of the pair of 3D glasses 1600, namely components 1301-1305, 1602, and 1603. The battery monitor 1602 monitors the remaining charge of the battery 1601 through the integration value of the voltage or power consumption of the battery 1601. The battery monitor 1602 further compares the remaining charge with a predetermined reference value (for example, 10%) to send an instruction to the notifying unit 1302 and the transmitter unit 1603 when the remaining charge reaches below the reference value. In response to the instruction, the notifying unit 1302 causes the light emission unit 1321 to emit visible light 1322. Thus, the user is reminded to replace or charge the battery 1601. The notifying unit 1302 may include a sound generating unit or a vibrator unit instead of the light emission unit 1321 and use sound or vibrations to remind the user to charge or change the battery 1601. The transmitter unit 1603 transmits a predetermined signal CR to the display device 101 in response to an instruction from the battery monitor 1602. The wireless communication method employed by the transmitter unit 1603 conforms to IrDA. Other examples of the wireless communication method include one using radio waves at RF bands, one conforming to IEEE 802.11, and one employing Bluetooth. In response to the signal CR, the display device 101 displays on the screen a message urging the viewer to replace or charge the battery 1601.

The instruction from the battery monitor 1602 may also be sent to the switching control unit 1303. In response to the instruction, the switching control unit 1303 causes both the lenses 1304 and 1305 to keep blocking light, by using the remaining charge of the battery 1601. In such a case, being unable to see anything through the pair of 3D glasses 1600, the user is notified that the battery 1601 needs to be replaced or charged. Alternatively, the switching control unit 1303 may cause only one of the lenses 1304 and 1305 to keep blocking light in response to the instruction from the battery monitor 1602. In that case, since the other lens passes light, the viewer is allowed to continuously watch the video images as 2D video images after the remaining charge of the battery 1601 falls below the reference value during the time the display device 101 displays 3D video images.

### <<Reference Embodiment 2>>

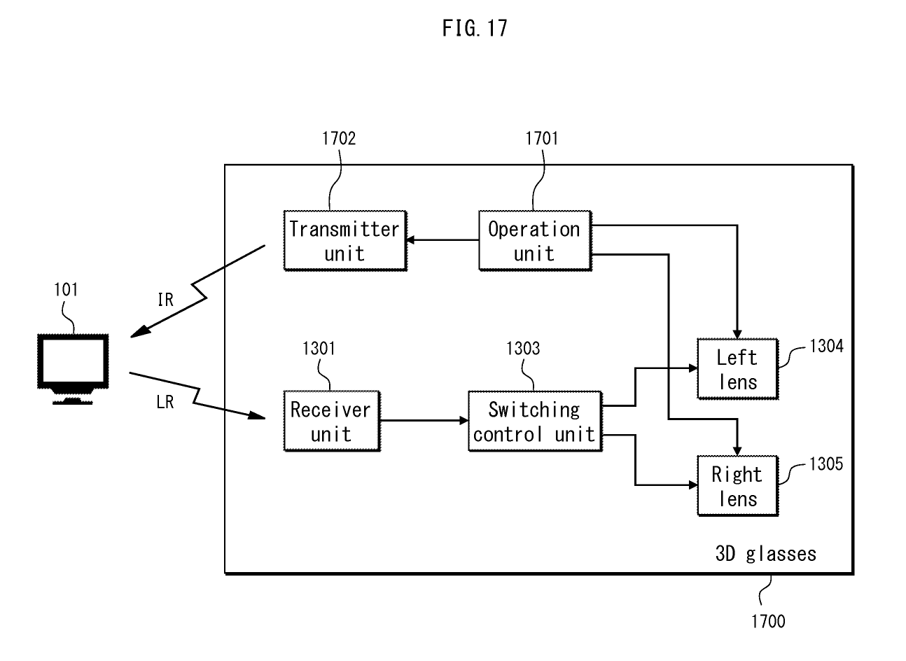

FIG. 17 is a block diagram showing the structure of a pair of 3D glasses 1700 according to Reference Embodiment 2. The structure shown in FIG. 17 differs from that shown in FIG. 13 in that an operation unit 1701 and a transmitter unit 1702 are included. Other components are the same as those shown in FIG. 13. Therefore, details of the same components can be found in the explanation about FIG. 13.

The operation unit 1701 includes a plurality of buttons similarly to the operation unit built into the remote control 103. Each button is provided on the frame of the pair of 3D glasses 1700 and assigned to a specific one of functions of the display device 101, including turning on and off of the power, a channel selection, and volume control. The functions include a function of adjusting the depth of 3D video images, i.e., the function of adjusting the parallax between the left- and right-view video images. The operation unit 1701 detects a push of a button by the user and transmits identification of the button to the transmitter unit 1702. Similarly to the transmitter unit built into the remote control 103, the transmitter unit 1702 converts the identification information of the button received from the operation unit 1701 into an infrared or radio signal IR and transmits the signal IR to the operation unit 1001 of the display device 101 shown in FIG. 10. The wireless communication method employed by the transmitter unit 1702 conforms to IrDA. Other examples of the wireless communication method include one using radio waves at RF bands, one conforming to IEEE 802.11, and one employing Bluetooth. On the other hand, the operation unit 1001 of the display device 101 receives the signal IR, specifies the button from the signal IR, and requests the state setting unit 1002 to execute the function assigned to the specified button. In the manner described above, the operation unit 1701 built into the pair of 3D glasses 1700 works in combination with the transmitter unit 1702 to perform the function equivalent to that of the remote control 103.

The subject of remote control by the combined use of the operation unit 1701 and the transmitter unit 1702 may be an external device other than the display device 101. Examples of such an external device include an optical disc player. The operation unit 1701 may additionally be used for operating the left lens 1304 and the right lens 1305. Suppose, for example, that the focal length of the lenses 1304 and 1305 is adjustable. Then, the operation unit 1701 may be used to adjust the focal length of each of the lenses 1304 and 1305, thereby adjusting its angle of view. Suppose, for example, that the pair of 3D glasses 1700 is provided with a speaker capable of reproducing the audio of broadcast content. Then, the operation unit 1701 may be used for volume control for the speaker.

### <<Reference Embodiment 3>>

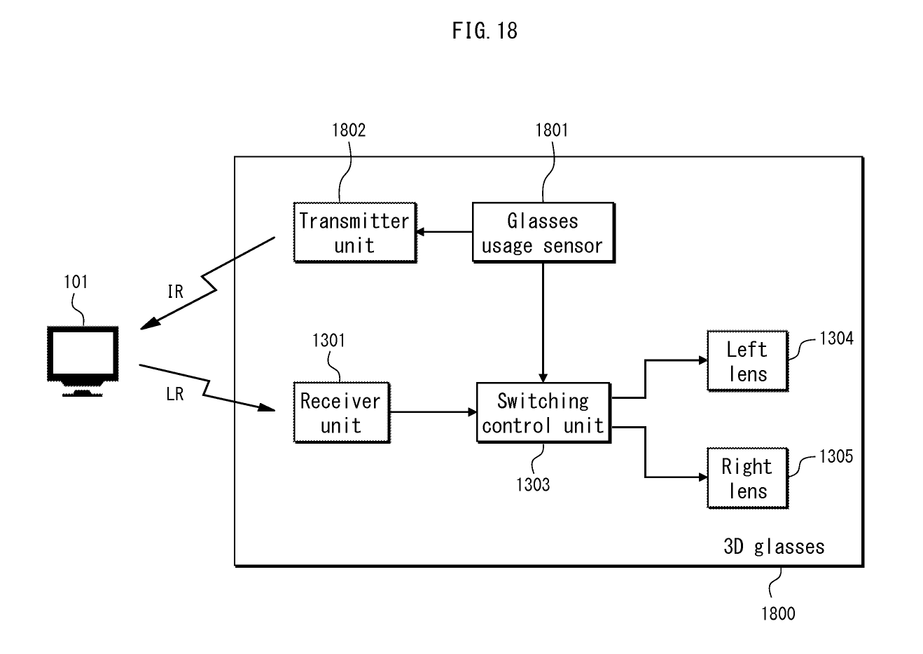

FIG. 18 is a block diagram showing the structure of a pair of 3D glasses 1800 according to Reference Embodiment 3. The structure shown in FIG. 18 differs from that shown in FIG. 13 in that a glasses usage sensor 1801 and a transmitter unit 1802 are included. Other components are the same as those shown in FIG. 13. Therefore, details of the same components can be found in the explanation about FIG. 13.

The glasses usage sensor 1801 is provided on the frame of the pair of 3D glasses 1800 and senses, for example, contact between the user's head and the frame, human body temperature, or interception of light by the user's head. Through the detection, the glasses usage sensor 1801 detects the wearing of the pair of 3D glasses 1800 by the user. The glasses usage sensor 1801 further notifies the transmitter unit 1802 of the detection. In response to the notification, the transmitter unit 1802 transmits the signal IR to the operation unit 1001 of the display device 101 shown in FIG. 10 by infrared or radio transmission. The signal IR transmitted here is for requesting the display device 101 to be turned on or to go into the 3D display mode. The wireless communication method employed by the transmitter unit 1802 conforms to IrDA. Other examples of the wireless communication method include one using radio waves at RF bands, one conforming to IEEE 802.11, and one employing Bluetooth. Upon receipt of the signal IR, the operation unit 1001 of the display device 101 requests the state setting unit 1002 to turn the power on or to set the 3D display mode. In the manner described above, the display device 101 is caused to start displaying 3D video images in a timed relation with the wearing of the pair of 3D glasses 1800 by the user. The signal IR may be further received by a Blu-ray™ disc player directly or via a high-definition multimedia interface (HDMI) cable to cause the player to change its output mode to the one supporting playback of 3D video images.

The glasses usage sensor 1801 may also detect the removal of the pair of 3D glasses 1800 from the user. Upon receipt of a notification of the detection from the glasses usage sensor 1801, the transmitter unit 1802 transmits the signal IR to the operation unit 1001 of the display device 101 by infrared or radio transmission. The signal IR transmitted here is for requesting the display device 101 to be turned off or to go into the 2D display mode. Upon receipt of the signal IR, the operation unit 1001 of the display device 101 requests the state setting unit 1002 to turn the power off or to set the 2D display mode. In the manner described above, the display device 101 is caused to switch from 3D video images to 2D video images in a timed relation with the removal of the pair of 3D glasses 1800 by the user. The signal IR may be further received by a Blu-ray disc player directly or via an HDMI cable to cause the player to change its output mode to the one supporting playback of 2D video images.

The glasses usage sensor 1801 may also notify the switching control unit 1303 of the wearing/removal of the pair of 3D glasses 1800 by the user. The switching control unit 1303 activates or deactivates the lenses 1304 and 1305 according to the notification. Thus, the lenses 1304 and 1305 operate only during the time the pair of 3D glasses 1800 is worn by the user, which saves drain of the battery of the pair of 3D glasses 1800.

The pair of 3D glasses 1800 may include a component that gives vibrations, pressure, or electrical stimulation to the user's head. The display device 101 may control the component via the receiver unit 1001 of the pair of 3D glasses 1800 synchronously with the 3D video images to provide a special effect through a tactile sensation to the user. In this case, the glasses usage sensor 1801 also notifies that component of the wearing of the pair of 3D glasses 1800 by the user. In response to the notification, the component goes active. Thus, the component operates only during the time the pair of 3D glasses 1800 is worn by the user, which saves drain of the battery of the pair of 3D glasses 1800.

### Reference Embodiment 4

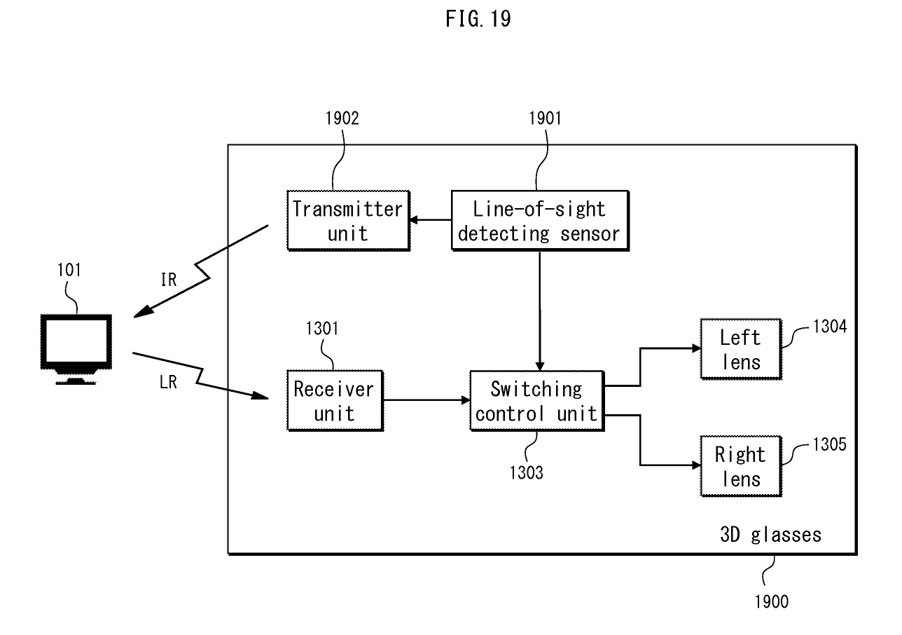

FIG. 19 is a block diagram showing the structure of a pair of 3D glasses 1900 according to Reference Embodiment 4. The structure shown in FIG. 19 differs from that shown in FIG. 18 in that a line-of-sight detecting sensor 1901 is included instead of the glasses usage sensor 1801. Other components are the same as those shown in FIG. 18. Therefore, details of the same components can be found in the explanation about FIG. 18.

The line-of-sight detecting sensor 1901 includes a compact camera supported on the frame of the pair of 3D glasses 1800. The line-of-sight detecting sensor 1901 captures the image of the eye of the user with the compact camera through the lens of the pair of 3D glasses 1800 and computes the direction of the line of sight from the position of the user's pupil appearing in the captured image. The line-of-sight detecting sensor 1901 further determines whether the line of sight is directed toward the screen of the display device 101. When detecting that the line of sight is directed toward the screen of the display device 101, the line-of-sight detecting sensor 1901 notifies the transmitter unit 1802 of the detection result. In response to the notification, the transmitter unit 1802 transmits the signal IR to the operation unit 1001 of the display device 101 shown in FIG. 10 by infrared or radio transmission. The signal IR transmitted here is for requesting the display device 101 to be turned on or to go into the 3D display mode. Upon receipt of the signal IR, the operation unit 1001 of the display device 101 requests the state setting unit 1002 to turn the power on or to set the 3D display mode. In the manner described above, the 3D video images are displayed on the display device 101 in relation with the timing at which the user is watching the screen of the display device 101 through the pair of 3D glasses 1900.

When detecting that the user's pupil is not in the image captured by the compact camera or that the user's line of sight is not directed toward the display device 101, the line-of-sight detecting sensor 1901 notifies the transmitter unit 1802 of the detection result. Upon receipt of the notification, the transmitter unit 1802 transmits the signal IR to the operation unit 1001 of the display device 101 by infrared or radio transmission. The signal IR transmitted here is for requesting the display device 101 to be turned off or to go into the 2D display mode. Upon receipt of the signal IR, the operation unit 1001 of the display device 101 requests the state setting unit 1002 to turn the power off or to set the 2D display mode. In the manner described above, the display device 101 is caused to switch from 3D video images to 2D video images when the user is not using the pair of 3D glasses 1900 or not viewing the screen of the display device 101 even if the user is wearing the pair of 3D glasses 1900.

The line-of-sight detecting sensor 1901 may also notifies the switching control unit 1303 of the detection result. The switching control unit 1303 activates or deactivates the lenses 1304 and 1305 according to the notification. Thus, the lenses 1304 and 1305 operate only during the time the user is viewing the screen of the display device 101 through the pair of 3D glasses 1900, which saves drain of the battery of the pair of 3D glasses 1900.

### Reference Embodiment 5

A display device according to Reference Embodiment 5 changes the polarization direction between when a left-view image is displayed and when a right-view video image is displayed on the screen. For example, the pixels of display device are divided into two groups, one of which is for displaying a left-view image and the other for displaying a right-view video image. The pixels for displaying a left-view image are covered by a polarization filter that passes only longitudinal components of light, whereas the pixels for displaying a right-view video image are covered by a polarization filter that passes only transverse components of light. That is, the left-view image is displayed on the screen with longitudinal polarization, whereas the right-view video image is displayed on the screen with transverse polarization.

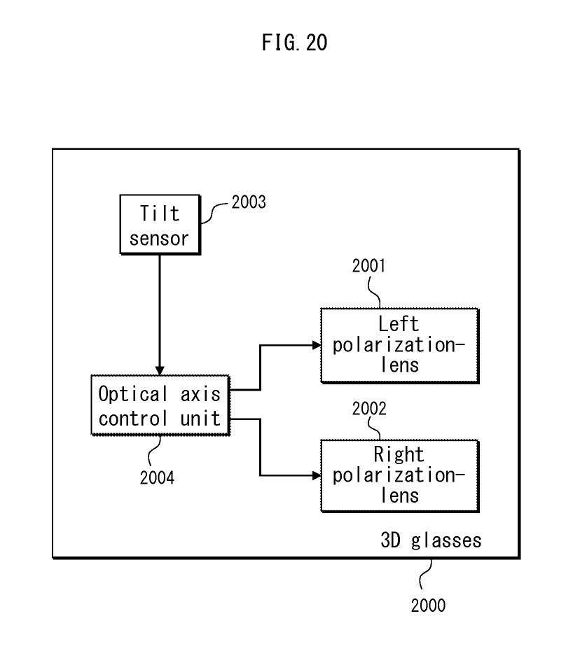

FIG. 20 is a block diagram showing the structure of a pair of 3D glasses 2000 according to Reference Embodiment 5. Referring to FIG. 20, the pair of 3D glasses 2000 includes a left polarization-lens 2001, a right polarization-lens 2002, a tilt sensor 2003, and an optical axis control unit 2004. The left polarization-lens 2001 and the right polarization-lens 2002 are each a polarization lens covered with a polarization film. The polarization lenses 2001 and 2002 are each rotatable about the normal of the lens surface. The tile sensor 2003 measures the tilt angle with respect to the horizontal plane containing the straight line passing through the center of both the right and left polarization lenses 2001 and 2002. The optical axis control unit 2004 adjusts the angle of rotation of each of the polarization lenses 2001 and 2002 according to the tilt angle measured by the tilt sensor 2003. Thus, the optical axis of each of the polarization lenses 2001 and 2002 is adjusted so that the longitudinal components of light emitted from the screen of the display device can only pass through the left polarization-lens 2001 and the traverse components can only pass through the right polarization-lens 2002. As a result, the pair of 3D glasses 2000 ensures that the user wearing the pair of 3D glasses 2000 correctly perceives the 3D video images displayed on the screen of the display device, regardless of the position and orientation of the user.

### Reference Embodiment 6

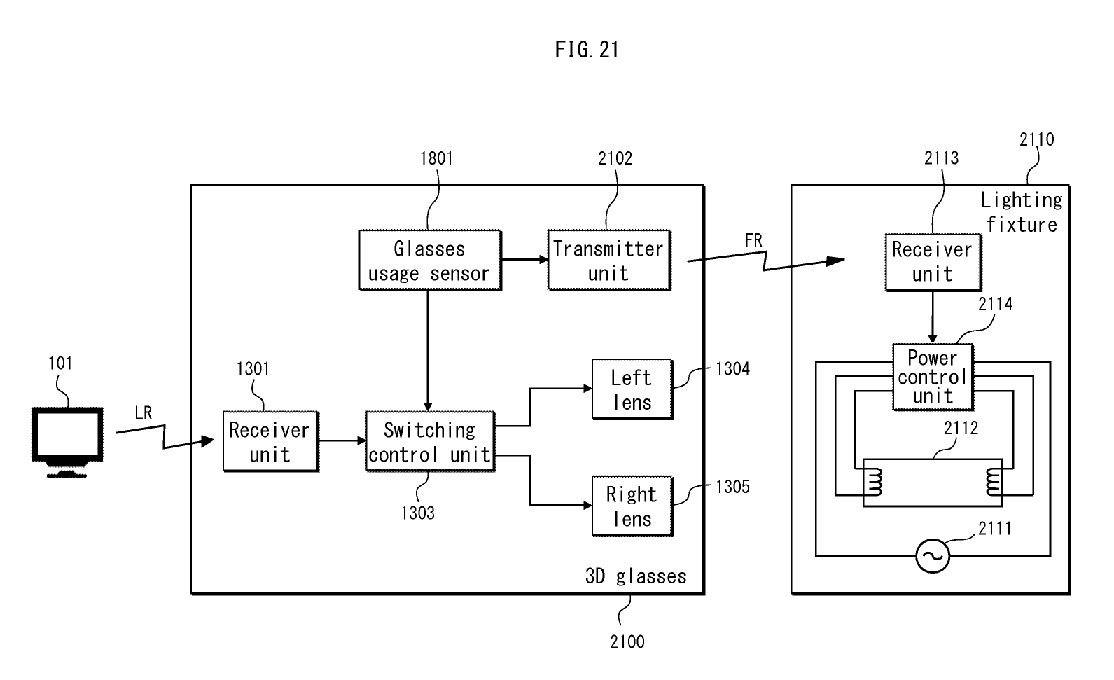

FIG. 21 is a block diagram showing the structure of a pair of 3D glasses 2100 and a lighting fixture 2110 according to Reference Embodiment 6. The lighting fixture 2110 is installed in the same room as the display device 101. The structure of the pair of 3D glasses 2100 shown in FIG. 21 is different from that shown in FIG. 18 in that a transmitter unit 2102 transmits a signal to the lighting fixture 2110. Other components are the same as those shown in FIG. 18. Therefore, details of the same components can be found in the explanation about FIG. 18.

The glasses usage sensor 1801 detects the wearing of the pair of 3D glasses 2100 by the user and gives a notification to the transmitter unit 2102. In response to the notification, the transmitter unit 2102 transmits a signal FR to the lighting fixture 2110 by infrared or radio transmission. The signal FR is for requesting to change the power frequency. The wireless communication method employed by the transmitter unit 2102 conforms to IrDA. Other examples of the wireless communication method include one using radio waves at RF bands, one conforming to IEEE 802.11, and one employing Bluetooth.

Referring to FIG. 21, the lighting fixture 2110 includes an AC power source 2111, a fluorescent tube 2112, a receiver unit 2113, and a power control unit 2114. The fluorescent tube 2111 receives and supplies AC power from a commercial AC power supply to the power control unit 2114. The fluorescent tube 2112 emits light on AC power received from the power control unit 2114. The receiver unit 2113 receives the signal FR from the transmitter unit 2102 of the pair of 3D glasses 2100. The wireless communication method employed by the receiver unit 2113 is the same as that employed by the transmitter unit 2102 of the pair of 3D glasses 2100. The receiver unit 2113 further sends an instruction to the power control unit 2114 in response to the signal FR. The power control unit 2114 includes an inverter. The power control unit 2114 normally keeps the inverter stopped and supplies the AC power from the AC power source 2111 as is to the fluorescent tube 2112. Therefore, the fluorescent tube 2112 flickers at 50 Hz or 60 Hz, which is the frequency of the commercial AC power supply. On the other hand, in response to the instruction from the receiver unit 2113, the power control unit 2114 uses the inverter to convert the AC power from the AC power source 2111 into one with a frequency sufficiently higher than that of the commercial AC power, e.g., AC power with tens of kHz, then supplying the converted AC power to the fluorescent tube 2112. When the user wears the 3D glasses 2100, the fluorescent tube 2112 thus blinks at the frequency sufficiently higher than that of the commercial AC power. As a result, the fluorescent tube 2112 blinks at the frequency sufficiently higher than 60 Hz, the frequency at which the lenses 1304 and 1305 of the 3D glasses 2100 repeatedly block light. Therefore, the user wearing the 3D glasses 2100 sees reduced flickering of the fluorescent tube 2112.

### Reference Embodiment 7

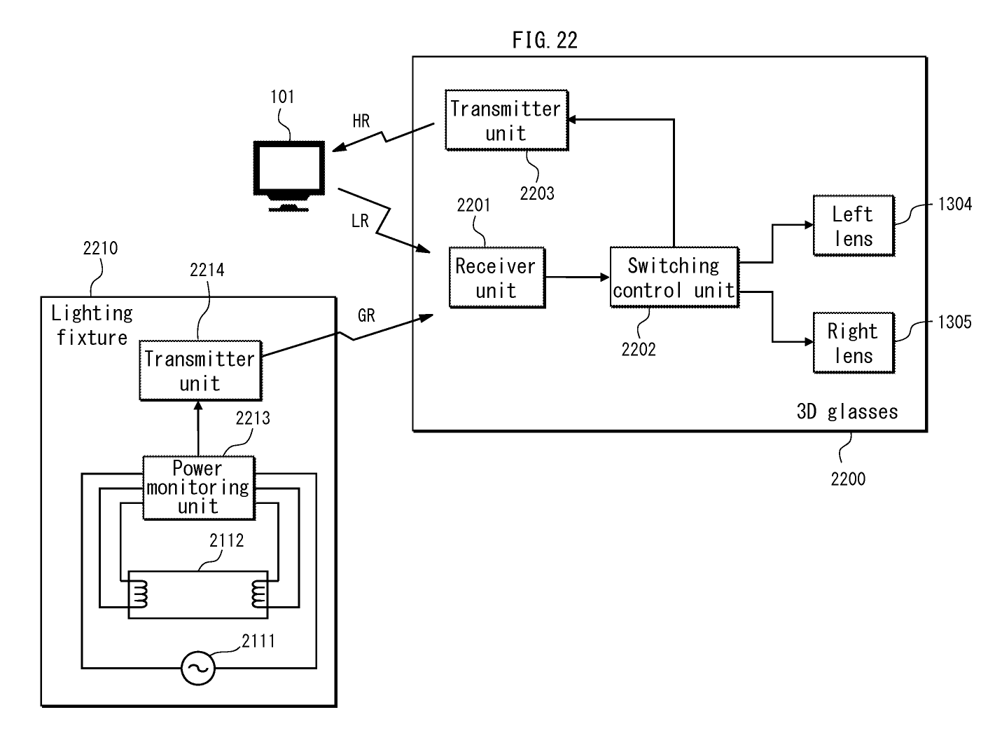

FIG. 22 is a block diagram showing the structure of a pair of 3D glasses 2200 and a lighting fixture 2210 according to Reference Embodiment 7. The lighting fixture 2210 is installed in the same room as the display device 101. The structure of the pair of 3D glasses 2200 shown in FIG. 22 differs from that shown in FIG. 13 with respect to a receiver unit 2201, a switching control unit 2202, and a transmitter unit 2202. Other components are the same as those shown in FIG. 13. Therefore, details of the same components can be found in the explanation about FIG. 13. The structure of the lighting fixture 2210 shown in FIG. 22 differs from that shown in FIG. 21 in that the receiver unit 2201 is replaced by a transmitter unit 2214 and that the power control unit 2114 is replaced by a power monitoring unit 2213. Other components are the same as those shown in FIG. 21. Therefore, details of the same components can be found in the explanation about FIG. 21.

In the lighting fixture 2210, the power monitoring unit 2213 supplies AC power as received from the AC power source 2111 to the fluorescent tube 2112, while monitoring the frequency of the AC power. The power monitoring unit 2214 further notifies the transmitter unit 2214 of the frequency of the AC power. In response to the notification, the transmitter unit 2214 transmits a signal GR to the pair of 3D glasses 2200 by infrared or radio transmission. The signal GR indicates information about the frequency of the AC power. The wireless communication method employed by the transmitter unit 2214 conforms to IrDA. Other examples of the wireless communication method include one using radio waves at RF bands, one conforming to IEEE 802.11, and one employing Bluetooth. In the pair of 3D glasses 2200, the receiver unit 2201 receives the left-right signal LR and the signal GR from the display device 101 and the lighting fixture 2210, respectively. The wireless communication method employed by the receiver unit 2201 is the same as that employed by the transmitter unit 1014 of the display device 101 with respect to the left-right signal LR, and the same as that employed by the transmitter unit 2214 of the lighting fixture 2210 with respect to the signal GR received from the lighting fixture lighting fixture 2210. The receiver unit 2201 detects the change in the left-right signal LR and notifies the switching control unit 2202 of the change. The receiver unit 2201 also reads the frequency of the AC power from the signal GR that is received from the lighting fixture 2210 and notifies the switching control unit 2202 of the frequency. The switching control unit 2202 further sends an instruction synchronously with the change in the left-right signal LR such that the instruction is sent to the left lens 1304 during the time a left-view image is displayed and to the right lens 1305 during the time right-view image is displayed. The switching control unit 2202 further adjusts the frequency at which to repeat the instruction to the lenses 1304 and 1305 to be different from the frequency of the AC power that is notified from the receiver unit 2201. Thus, the frequency at which the lenses 1304 and 1305 of the pair of 3D glasses 2200 repeat blocking of light is asynchronous with the frequency at which the fluorescent tube 2112 blinks.

Therefore, flickering of the fluorescent tube 2112 noticeable to the user wearing the pair of 3D glasses 2200 is reduced. The frequency thus adjusted is informed to the transmitter unit 2203 by the switching control unit 2202. The transmitter unit 2203 then sends a signal HR indicating the adjusted frequency to the operation unit 1001 of the display device 101. The wireless communication method employed by the transmitter unit 2203 is the same as that employed by the remote control 103.

The display device 101 receives the signal HR from the transmitter unit 2203 of the pair of 3D glasses 2200 and reads the adjusted frequency from the signal HR. The display device 101 adjusts the frequency at which switching between a left-view video frame and a right-view video frame takes place to match the frequency read from the HR signal. Consequently, the frequency of the left-right signal LR is made to match to the adjusted frequency. That is, the time period during which the display device 101 displays a left-view image is synchronized with the time period during which the left lens 1304 of the pair of 3D glasses 2200 passes light, and the time period during which the display device 101 displays a right-view image is synchronized with the time period during which the right lens 1305 of the pair of 3D glasses 2200 passes light. In this way, the user wearing the pair of 3D glasses 2200 is enabled to watch 3D video images appropriately.

### INDUSTRIAL APPLICABILITY

The present invention relates to a technology for displaying 3D video images. As described above, a pair of 3D glasses operates to urge the viewer to use the pair of 3D glasses when broadcast content to be displayed contains 3D video images. The present invention thus clearly has industrial applicability.

### REFERENCE SIGNS LIST

101 display device

1001 operation unit

1002 state setting unit

1003 packet analyzing unit

1030 receiver unit

1031 tuner

1032 NIC

1033 demultiplexer unit

1034 management packet processer unit

1004 decoding unit

1005 FB1

1006 display determining unit

1007 display processing unit

1008 FBL

1009 FBR

1010 switch

1011 display unit

1012 audio output unit

1013 3D video image detecting unit

1014 transmitter unit

102 pair of 3D glasses

103 remote control

104 antenna

105 network

LR left-right signal

NF notification signal

1. A display device for receiving a broadcast stream to display video images of broadcast content represented by the broadcast stream, comprising:
a state setting unit configured to store a parameter therein, the parameter indicating a state of the display device;
a packet analyzing unit configured to refer to the parameter stored in the state setting unit to receive the broadcast stream, and analyze management packets contained in the broadcast stream;
a decoding unit configured to use a result of analyzing by the packet analyzing unit to extract packets that constitute the broadcast content from the broadcast stream, and decode the packets into a series of video frames;
a display unit configured to display two-dimensional (2D for short) or three-dimensional (3D for short) video images represented by the series of video frames;
a 3D video image detecting unit configured to use a result of analyzing by the packet analyzing unit to determine whether broadcast content to be displayed contains 3D video images or not; and
a transmitter unit configured to transmit a notification signal to a pair of 3D glasses when the 3D video image detecting unit detects that the broadcast content to be displayed contains 3D video images, the notification signal requiring the pair of 3D glasses to operate to urge a viewer to use the pair of 3D glasses.

2. The display device according to claim 1 wherein
the parameter referred to by the packet analyzing unit specifies a provider or broadcasting station that is currently selected as a source of a broadcast stream to be received, and
the result of analyzing used by the 3D video image detecting unit relates to a broadcast guidance information packet, which is one of the management packets assigned to broadcast content that the provider or broadcasting station currently distributes.

3. The display device according to claim 1 wherein
the parameter referred to by the packet analyzing unit specifies details of preselection of broadcast content to be watched, and
the result of analyzing used by the 3D video image detecting unit relates to a broadcast guidance information packet, which is one of the management packets assigned to the broadcast content preselected to be watched.

4. The display device according to claim 1 wherein
the parameter referred to by the packet analyzing unit specifies a provider or broadcasting station that is currently selected as a source of a broadcast stream to be received, and
the result of analyzing used by the 3D video image detecting unit relates to a content management packet, which is one of the management packets assigned to the broadcast stream that the provider or broadcasting station currently distributes.

5. The display device according to claim 1 wherein
the parameter referred to by the packet analyzing unit specifies details of preselection of broadcast content to be watched,
the details include an identifier of a user who programs the preselection or an identifier of a pair of 3D glasses to be used by the user, and
the transmitter unit incorporates the identifier of the user or the pair of 3D glasses into the notification signal.

6. A pair of 3D glasses to be used by a viewer to watch 3D video images of broadcast content represented by a broadcast stream when a display device receives the broadcast stream and displays the 3D video images, comprising:
a left lens configured to selectively transmit left-view images displayed on the display device;
a right lens configured to selectively transmit right-view images displayed on the display device;
a receiver unit configured to receive a notification signal when the display device detects that broadcast content to be displayed contains 3D video images while analyzing management packets contained in the broadcast stream in order to determine whether the broadcast content to be displayed contains 3D video images or not; and
a notifying unit configured to operate to urge the viewer to use the pair of 3D glasses in response to the notification signal.

7. The pair of 3D glasses according to claim 6 wherein the notifying unit includes a light emission unit configured to emit visible light, and in response to the notification signal, causes the light emission unit to emit the visible light.

8. The pair of 3D glasses according to claim 6 wherein the notifying unit includes a sound generating unit configured to generate audible sound, and in response to the notification signal, causes the sound generating unit to generate the audible sound.

9. The pair of 3D glasses according to claim 6 wherein the notifying unit includes a vibrator unit having a vibratile member built in, and in response to the notification signal, causes the vibrator unit to vibrate the member.

10. The pair of 3D glasses according to claim 6 wherein
the notifying unit includes an identifier verifying unit configured to compare an identifier of the user or the pair of 3D glasses with a predetermined identifier when the notification signal indicates the identifier of the user or the pair of 3D glasses, and
the notifying unit responds to the notification signal when the identifier verifying unit detects that the identifier of the user or the pair of 3D glasses matches with the predetermined identifier.

11. The pair of 3D glasses according to claim 6 further comprising
a switching control unit configured to receive a signal indicating whether left- or right-view images are displayed on the display device, and in response to the signal, to provide the left and right lenses with a signal indicating when to transmit or block light, wherein
the left and right lenses each include a liquid crystal panel configured to transmit and block light in response to the signal provided by the switching control unit, and
in response to the notification signal, the notifying unit causes the left and right lenses to transmit and block light with predetermined timing.

12. A system to be used by a viewer to watch video images of broadcast content, comprising:
a display device configured to receive a broadcast stream representing the broadcast content to display 2D or 3D video images of the broadcast content; and
a pair of 3D glasses to be used by the viewer to watch the 3D video images, wherein the display device includes:
a state setting unit configured to store a parameter therein, the parameter indicating a state of the display device;
a packet analyzing unit configured to refer to the parameter stored in the state setting unit to receive the broadcast stream, and analyze management packets contained in the broadcast stream;
a decoding unit configured to use a result of analyzing by the packet analyzing unit to extract packets that constitute the broadcast content from the broadcast stream, and decode the packets into a series of video frames;
a display unit configured to display 2D or 3D video images represented by the series of video frames;
a 3D video image detecting unit configured to use a result of analyzing by the packet analyzing unit to determine whether broadcast content to be displayed contains 3D video images or not; and
a transmitter unit configured to transmit a notification signal to the pair of 3D glasses when the 3D video image detecting unit detects that the broadcast content to be displayed contains 3D video images, and the pair of 3D glasses includes:
a left lens configured to selectively transmit left-view images displayed on the display device;
a right lens configured to selectively transmit right-view images displayed on the display device;
a receiver unit configured to receive the notification signal from the display device; and
a notifying unit configured to operate to urge the viewer to use the pair of 3D glasses in response to the notification signal.
